(19) United States
(12) Patent Application Publication
(10) Pub. No.: US 2026/0311027 A1
(43) Pub. Date: Oct. 8, 2026

(54) Recognition-Enhanced Quantum Search ("Grover-phi")

(71) Applicant: Jonathan Washburn, Austin, TX (US)

(72) Inventor: Jonathan Washburn, Austin, TX (US)

(21) Appl. No.: 19/640,194

(22) Filed: Apr. 6, 2026

Related U.S. Application Data
(60) Provisional application No. 63/784,811, filed on Apr. 7, 2025.

(51) Int. Cl. G06N 10/60

(52) U.S. Cl. CPC G06N 10/60

(57) ABSTRACT

A recognition-enhanced quantum search system, method, and computer-readable medium are disclosed in which a quantum search process distinguishes among marked solution states, a first class of non-solution states, and a second class of non-solution states during iterative amplitude amplification. A quantum state is prepared over a search domain, an oracle operation marks one or more candidate states satisfying a target criterion, a vantage metric is determined for at least a subset of non-solution states, a recognition diffusion operation is applied relative to a recognition-weighted state representation derived from the vantage metric, and a state-dependent transform applies different phase treatments to the different state classes. In representative embodiments, stronger suppression is applied to vantage-likely non-solution states than to other non-solution states. The process may use an effective-domain value for iteration control and may attenuate or bypass the state-dependent transform when the vantage metric is unavailable or insufficiently informative.

### CROSS-REFERENCE TO RELATED APPLICATIONS

This application is a non-provisional application and claims priority to U.S. Provisional Patent Application No. 63/784,811, filed on Apr. 7, 2025. The subject matter of U.S. Provisional is incorporated by reference herein in its entirety to the extent permitted by applicable law and to the extent not inconsistent with the present disclosure.

### BACKGROUND OF THE INVENTION

The present disclosure relates generally to quantum computing, quantum search, and computational control of amplitude amplification in quantum information processing systems. More particularly, the present disclosure relates to recognition-enhanced quantum search architectures, methods, circuits, and control logic that modify a Grover-type search process by introducing recognition-driven state categorization, weighted diffusion behavior, and state-dependent transform operations that suppress selected non-solution states according to a vantage-likelihood measure. In representative embodiments, the disclosed subject matter is applicable to quantum database search, satisfiability solving, combinatorial optimization, graph-based search, cryptanalytic search, machine-learning hyperparameter exploration, and other search or selection tasks in which at least part of the non-solution search space can be objectively characterized as structurally unfavorable, noise-prone, decoherence-prone, or otherwise less suitable for continued amplification.

Quantum search techniques based on amplitude amplification, including Grover-type algorithms, are widely understood to provide a quadratic improvement over classical exhaustive search for a fully unstructured search domain. In a conventional Grover process, an oracle marks a target state or target subset, and a diffusion operator reflects amplitudes about an average state so that repeated iterations increase target-state amplitude and decrease non-target amplitude. For an ideal, fully unstructured, noiseless search space, that framework provides a useful baseline and is often described in terms of a square-root iteration count relative to the nominal domain size.

Although that baseline is important, it does not resolve several technical shortcomings that arise in practical search systems, particularly where the search domain is not perfectly uniform, where the hardware is noisy, where the environment couples more strongly to some basis states than others, where structural information is available but not exploited at the amplitude-control level, or where the system designer seeks reproducible control over which non-solution states are suppressed first. In such settings, conventional oracle-plus-diffusion behavior can be operationally incomplete because it treats broad classes of non-solution states as interchangeable even when they are not interchangeable from a control, stability, or implementation standpoint.

One shortcoming of prior Grover-type approaches is that they generally do not provide a disclosed mechanism for partitioning the non-solution portion of the search space into technically distinct categories that can be acted upon differently during amplitude evolution. In many practical problems, some non-solution states are more likely than others to absorb amplitude wastefully, to correspond to structurally poor candidates, to sit in high-constraint or high-conflict regions of a problem landscape, to align with leakage-sensitive patterns, or to act as noise-attractor states under a given hardware or environment model. Conventional Grover diffusion nonetheless reflects globally without introducing a disclosed category-specific suppression rule for such states. As a result, the system may continue spending iterations redistributing amplitude among non-solution states that are already known, inferred, or estimated to be poor candidates for solution retention. This can matter in operational terms because circuit depth, coherence time, readout budget, and error accumulation are finite resources. When those resources are consumed amplifying and re-amplifying states that should instead be deprioritized, the search system can become less predictable, less robust, and less controllable.

A related shortcoming is that conventional Grover-type search generally lacks a disclosed recognition-weighted diffusion mechanism that biases the reflection behavior according to a state-dependent measure of structural or environmental undesirability. Standard diffusion treats the search space in a uniform manner relative to the selected superposition basis. That uniformity is mathematically elegant for an idealized unstructured search model, but it is not necessarily well matched to practical settings in which an objective score, tag, or classifier can distinguish relatively undesirable non-solution states from relatively preferable non-solution states. Without a weighting architecture, the system does not natively encode the difference between a merely unmarked state and a state that is affirmatively likely to trap noise, degrade convergence, violate many constraints, or otherwise deserve stronger suppression. Prior approaches therefore leave unaddressed the technical problem of translating available state-quality information into a unitary search-control framework that remains compatible with iterative amplitude amplification.

Another shortcoming concerns hardware noise, decoherence, and environment-coupled instability. In practical quantum hardware, amplitude evolution is not performed in an ideal mathematical vacuum. Gate infidelity, decoherence, crosstalk, leakage, bias in measurement or control channels, and basis-dependent environmental interactions can alter the expected trajectory of amplitude concentration. Under such conditions, target-state amplitude may broaden rather than sharpen, peak locations may shift, and repeated iterations may cease to improve success probability in the expected manner. Conventional Grover formulations generally do not include a disclosed mechanism for intentionally redirecting or quarantining noise-sensitive amplitude away from selected classes of non-solution states that are already recognized as poor candidates. Instead, all non-solution states are effectively treated as participants in the same broad diffusion pool. That omission can be consequential because a search process that remains theoretically optimal in an ideal unstructured model may still perform unreliably in actual hardware when the error process is state-sensitive rather than uniform.

Another technical limitation of prior approaches is the absence of a disclosed effective-domain framework that distinguishes nominal domain size from operational domain size after controlled suppression of selected non-solution states. Conventional Grover analysis is ordinarily expressed relative to the original domain cardinality. However, in many practical problems the meaningful search burden may depend not only on the total number of basis states but also on whether a disclosed control regime can identify a subset of non-solution states that should be penalized, down-weighted, bypassed, or otherwise treated as less eligible for continued amplification. Without such a framework, the algorithmic control layer cannot formally exploit pruning-related information that is weaker than full solution knowledge but still stronger than complete ignorance. This matters because many real systems operate in an intermediate regime between totally unstructured search and fully solved search. In that intermediate regime, the designer may know enough to classify part of the search space as structurally disfavored without knowing the exact solution in advance. Prior approaches do not adequately convert that intermediate information into a concrete state-transform architecture tied to reproducible control operations.

Prior approaches also tend to under-specify how partial structural knowledge should be sourced, represented, updated, or operationalized during a quantum search. For example, a search controller may have access to constraint-density information in a satisfiability problem, graph-degree or centrality information in a graph search problem, side-channel or leakage-pattern information in a cryptanalytic setting, corruption-pattern information in a database setting, or prior-distribution information in a Bayesian search setting. Yet conventional Grover formulations do not disclose an integrated mechanism that converts such information into a state-dependent control variable that then drives different transform behavior during iteration. In the absence of such machinery, any claimed use of structure risks becoming merely aspirational or heuristic rather than a concrete, machine-actionable architecture. A practical search system, by contrast, benefits from objective inputs, defined transformation rules, explicit state categories, and a repeatable way to apply control consequences to those categories.

Another shortcoming lies in the lack of robust fallback behavior in prior structure-modified search proposals. In practice, an algorithm should not be locked into an allegedly improved transform when the underlying structural signal is weak, unavailable, misleading, or non-informative. A useful technical architecture should therefore distinguish between a condition in which structure-aware suppression is beneficial and a condition in which ordinary Grover behavior should be preserved. Prior systems frequently fail to define that boundary in an implementation-ready manner. This creates uncertainty in deployment because the operator may not know when a modified transform should be activated, attenuated, or bypassed. That uncertainty can degrade reproducibility, make benchmarking less meaningful, and complicate examiner review by blurring the difference between an algorithm that actually discloses a regime-selection mechanism and one that merely states aspirational advantages.

Conventional approaches also provide limited support for application-specific embodiments in which the same search architecture is adapted across different technical domains while preserving a stable core control logic. Database search, satisfiability solving, graph optimization, cryptanalysis, and machine-learning search each expose different forms of partial structure and different forms of state undesirability. Yet prior amplitude-amplification frameworks do not generally disclose a single architecture in which a common state-categorization mechanism, a common weighted-diffusion mechanism, and a common state-dependent transform can be reused while allowing different sources of classification input. The absence of such a unified architecture makes it harder to standardize circuit design, simulator behavior, compiler support, benchmarking, and deployment pathways across use cases.

In addition, prior search formulations frequently blur important technical distinctions. For example, they may fail to distinguish between detecting a state property and acting on that property, between classifying a state as undesirable and proving that the state is not a solution, between reducing practical search burden and claiming universal asymptotic dominance on every domain, between a presentation-level score and a machine-actionable control variable, or between an idealized unstructured regime and a structured noisy regime. Those distinctions matter for implementation and prosecution because a search algorithm should be described in terms of what objective information is received, what decision logic is executed, what transform is applied, what output behavior changes, and under what conditions fallback behavior is invoked.

Accordingly, a need exists for improved quantum search technology that goes beyond undifferentiated oracle marking and uniform diffusion, and instead introduces a concrete technical architecture for identifying selected non-solution states, assigning those states a vantage-likelihood or related control metric, applying recognition-weighted diffusion, and imposing stronger or weaker transform consequences on different non-solution categories while leaving solution-state treatment distinct. A further need exists for a search architecture that supports effective-domain reasoning without incorrectly asserting universal superiority over ideal unstructured Grover search on the same unchanged domain, that improves control in partially structured or noise-affected regimes, that supports objective sources of state classification, that can be implemented in circuit, system, software, compiler, simulator, or service form, and that includes fallback operation when the structural signal is absent or not sufficiently informative.

The present disclosure addresses these and other shortcomings by providing recognition-enhanced quantum search architectures in which non-solution states are not treated as a single undifferentiated population, but are instead selectively categorized and acted upon through a defined combination of oracle marking, recognition diffusion, and a minimal-overhead transform that applies different phase behavior to different state classes.

### SUMMARY OF THE INVENTION

The present disclosure provides systems, methods, devices, circuits, software, and compiler-implemented processes for recognition-enhanced quantum search, also referred to in certain embodiments as Grover-phi, in which a quantum search process is modified to distinguish among different categories of states and to apply different search-control behavior to those categories during iterative amplitude amplification. In representative embodiments, the disclosed technology addresses a technical problem that arises when a search space is not operationally uniform, such as where a subset of non-solution states is structurally disfavored, constraint-heavy, leakage-prone, noise-attractive, environmentally coupled, or otherwise more likely to absorb amplitude in a manner that degrades convergence efficiency, stability, or predictability.

In representative embodiments, the disclosed technology provides a technical improvement in operation of a quantum search system by introducing a machine-controlled, state-dependent phase-routing architecture that reduces reinjection of amplitude into a subset of non-solution states identified as noise-attractive or structurally disfavored under objective kappa generation, thereby improving robustness and predictability under basis-dependent noise for a fixed circuit-depth budget. In such embodiments, the improvement is realized by concrete machine operations including kappa evaluation on an ancilla register, recognition-weighted diffusion, and kappa-controlled application of different phase treatments to different state classes, optionally under transform-enable gating responsive to objective confidence and objective noise estimates, rather than by a mere presentation of search results or by a purely abstract classification without unitary consequences.

Rather than treating all non-solution states identically, the disclosed architecture introduces recognition-based state categorization, recognition-weighted diffusion, and a state-dependent transform that selectively suppresses selected non-solution states while preserving distinct treatment for marked solution states. In one aspect, the disclosure provides a quantum search method comprising preparing a superposition over a plurality of candidate states, applying an oracle operation that marks one or more solution states, applying a recognition diffusion operation that reflects relative to a recognition-weighted state representation, applying a minimal-overhead transform that applies an identity treatment to marked solution states and different phase consequences to different categories of non-solution states, and measuring the resulting state after a selected number of iterations. In representative embodiments, the iterative search cycle includes three ordered operations, namely oracle marking, recognition diffusion, and minimal-overhead transform, and that cycle is repeated until a stop condition is satisfied. The stop condition can be based on a predetermined iteration budget, an estimated convergence level, an amplitude estimate, a confidence threshold, a depth limit, a policy rule, a hardware limit, an effective-domain value, or another machine-actionable termination criterion. In another aspect, the disclosure provides a state-categorization framework in which the search space is partitioned into at least marked solution states, vantage-likely non-solution states, and other non-solution states. A vantage-likely non-solution state, as used in non-limiting embodiments of the present disclosure, is a state that is estimated, classified, or determined to be more likely than other non-solution states to represent a structurally poor candidate, to align with a known unfavorable region of the problem landscape, to attract noise or decoherence, to correspond to a high-conflict or high-constraint assignment, or otherwise to warrant stronger suppression during the search process. The categorization need not prove that a state is impossible as a solution merely because the state is vantage-likely; instead, the categorization supplies a control variable that can be used to govern differential transform behavior. This distinction is important because the disclosed technology is directed to search control, not merely to abstract labeling. In another aspect, the disclosure provides a vantage cost function or related control metric, denoted in some embodiments as kappa(x), that quantifies whether a candidate state is to receive stronger suppression, weaker suppression, or an intermediate level of suppression. In some embodiments, kappa(x) is binary, such that one class of non-solution states receives a first penalty class and another class receives a second penalty class. In other embodiments, kappa(x) is continuous or multi-level, allowing a graded phase schedule across multiple non-solution states. The disclosed kappa value can be generated from problem structure, environment-coupling information, a Bayesian prior, historical run data, a learned classifier, a rule-based analyzer, a constraint-density computation, a graph-property computation, a side-channel or leakage model, a corruption-pattern detector, a machine-learning performance predictor, or combinations thereof. Thus, the disclosure is not limited to a single source of state-quality information so long as the output is transformed into a machine-actionable control variable for use by the search architecture. In another aspect, the disclosure provides a recognition diffusion operator that is not merely a conventional average-state reflection but instead is constructed relative to a recognition-weighted superposition. In representative embodiments, the recognition diffusion operator is a unitary reflection about a weighted state vector defined from one or more weights that are monotone in the vantage metric. By allowing the reflection axis itself to incorporate objective state distinctions, the disclosed recognition diffusion operation changes how amplitude is redistributed among candidate states and thereby improves control over which states remain amplification-eligible during repeated cycles. In some embodiments, the recognition diffusion operation is implemented directly as a weighted reflection. In other embodiments, the recognition diffusion operation is implemented through a baseline diffusion structure combined with an offset weighting, phase-bias, or related modifier that approximates or realizes the weighted reflection behavior in a hardware-efficient manner. In another aspect, the disclosure provides a minimal-overhead transform, denoted in certain embodiments as U_phi, that leaves marked solution states unpenalized while imposing a stronger phase penalty on vantage-likely non-solution states and a weaker phase penalty on other non-solution states. In representative binary embodiments, marked states receive identity treatment, vantage-likely non-solution states receive a stronger phase treatment, and other non-solution states receive a weaker phase treatment, where phi is the golden ratio and a transform penalty parameter is selected to govern relative treatment strength.

In continuous embodiments, the transform can apply a generalized phase schedule as a function of kappa(x) and an associated normalization or scaling rule. Because the transform is phase-based, it can be implemented in circuit form as a diagonal operator, including in ancilla-assisted or classifier-assisted embodiments. The technical effect of this architecture is not merely that different states are named differently, but that the machine applies objectively different unitary treatment to different classes of non-solution states during the same amplitude amplification framework. In another aspect, the disclosure provides an effective-domain framework in which the practical search burden is characterized not solely by a nominal domain size N, but by an effective domain N_eff associated with the portion of the state space that remains materially relevant after selective suppression of vantage-likely non-solution states. In representative embodiments, the disclosed method can be operated and analyzed with respect to an effective-domain size that is smaller than the original domain size when a meaningful portion of non-solution states is classified for stronger suppression. This framework is particularly useful in partially structured search spaces and in noise-affected regimes. The disclosure therefore supports technical advantages tied to reduced practical search burden and improved robustness in such regimes. At the same time, the disclosure does not require, and should not be read as asserting, that the same transform universally outperforms ideal standard Grover search on the same unchanged fully unstructured domain. Rather, the disclosed value proposition is tied to state categorization, effective-domain reduction, and/or improved operation under noise, decoherence, or structurally non-uniform search conditions. In another aspect, the disclosure provides explicit fallback operation for regimes in which the structure signal is absent, weak, or not sufficiently informative. In representative embodiments, when kappa is constant, uninformative, unavailable, or determined not to justify the additional transform behavior, the implementation may omit the minimal-overhead transform, may set a transform penalty parameter to zero, may attenuate the transform, or may otherwise reduce to standard Grover-like behavior. This fallback behavior is technically important because it allows a compiler, controller, or execution platform to distinguish between structured/noisy regimes in which recognition-enhanced suppression is beneficial and unstructured regimes in which ordinary Grover behavior is preferred. The disclosure therefore supports a regime-selection architecture rather than a one-mode algorithm that is applied indiscriminately in every setting. In another aspect, the disclosure provides quantum circuit embodiments in which a state register, an ancilla register, one or more classifier or evaluator blocks, an oracle block, a recognition diffusion block, and a controlled phase-transform block are combined under control of a classical or hybrid controller. In some embodiments, the ancilla register is used to evaluate or store a kappa-related flag, category indicator, or continuous score. In some embodiments, a compiler or runtime system converts a user-specified problem instance and associated structure hints into an executable circuit schedule that includes oracle marking, kappa evaluation, recognition diffusion, and selective phase application. In some embodiments, the disclosure further provides device-level, simulator-level, cloud-service, software-library, and primitive-based implementations that expose the recognition-enhanced search process as a callable search service or search instruction set. In another aspect, the disclosure provides adaptive embodiments in which a transform penalty parameter, kappa, or both are updated during execution. Such updates may be based on intermediate measurement data, amplitude estimation, estimated error conditions, a changing environment model, or a policy-driven convergence monitor. In still other embodiments, the minimal-overhead transform is applied stroboscopically, such as every k-th iteration instead of every iteration, allowing a tradeoff between pruning aggressiveness and circuit depth. In still other embodiments, the disclosed search architecture is combined with classical preprocessing, such as identifying vantage-likely candidates using a classical feature extractor, rule engine, or classifier before the quantum phase of execution begins, and storing resulting class indicators, scores, or thresholds for later use in kappa evaluation or transform-enable decisions during the quantum phase. In still other embodiments, the disclosed transform logic is integrated into hybrid architectures including Grover-style search combined with QAOA-style mixers, quantum walk operations, nested search loops, or domain-specific search controllers. These embodiments broaden implementation coverage while preserving the same core technical principle of differential treatment of selected non-solution states. In another aspect, the disclosure provides application-specific implementations for database search, satisfiability solving, graph optimization, cryptanalysis, machine-learning hyperparameter search, and related technical fields. In a database embodiment, kappa can be derived from corruption patterns, access profiles, or other indicators of unfavorable candidate regions. In a satisfiability embodiment, kappa can be derived from clause-violation counts, conflict density, or related structural measures. In a graph embodiment, kappa can be derived from degree, centrality, cut structure, or related graph properties. In a cryptanalytic embodiment, kappa can be derived from side-channel leakage patterns or related implementation-specific indicators. In a machine-learning embodiment, kappa can be derived from prior generalization behavior or from regions of hyperparameter space identified as unfavorable. These examples are illustrative and not limiting, and they show that the disclosed search-control framework is reusable across multiple technical domains without requiring the core architecture to be redefined for each use case. The present disclosure also provides systems and methods for formal verification, auditing, benchmarking, and reproducibility of the disclosed search architecture. In non-limiting embodiments, theorem-backed or simulation-backed validation can be used to confirm properties such as ordered treatment strength between different non-solution classes, reduction in the effective domain when vantage-pruning assumptions hold, preservation of no-penalty treatment for marked states, and definition of the disclosed three-step iteration cycle. Such validation mechanisms are supportive of operability, reproducibility, and engineering confidence, and in some embodiments include storing a selected transform penalty parameter value, a selected kappa policy, a transform-enable decision, an effective-domain estimate, and a measurement result in an execution log, but the invention is not limited to any particular proof assistant, simulator, or validation framework unless expressly recited. Accordingly, the disclosure provides a concrete technical solution to a concrete technical problem. The technical problem is that prior amplitude-amplification search frameworks do not adequately distinguish among different types of non-solution states in structured or noise-affected environments and therefore do not provide objective, machine-actionable control over selective suppression of states that should be deprioritized. The technical solution is a recognition-enhanced quantum search architecture that combines state categorization, a recognition-weighted diffusion mechanism, and a state-dependent transform to alter amplitude evolution in a controlled and reproducible manner. The resulting technical effects can include improved operational robustness, reduced practical search burden in applicable effective-domain regimes, better exploitation of partial structure, more predictable behavior under non-uniform noise conditions, greater deployment flexibility, and stronger support for implementation across circuit, system, software, device, and service embodiments. The foregoing summary is illustrative and is not intended to define the full scope of the invention, which is set forth more fully in the drawings, detailed description, and claims that follow.

### BRIEF DESCRIPTION OF THE DRAWINGS

FIG. 1 is a schematic block diagram of a recognition-enhanced quantum search system configured to execute a Grover-phi search process using a state preparation subsystem, an oracle subsystem, a recognition diffusion subsystem, a minimal-overhead transform subsystem, a measurement subsystem, and associated classical control, parameter-generation, and result-processing components.

FIG. 2 is a process flow diagram of a recognition-enhanced quantum search method showing preparation of a candidate-state superposition, oracle marking, vantage-metric determination, recognition diffusion, minimal-overhead transform application, iteration control, optional parameter updating, measurement, decoding, and output generation.

FIG. 3 is a conceptual diagram of search-space partitioning showing a solution subset, a non-solution subset, a vantage-likely subset, an other-state subset, a suppressed or pruned subset, and an effective-domain representation associated with selective suppression of selected non-solution states.

FIG. 4 is a schematic diagram of an oracle marking subsystem configured to evaluate candidate states against a solution criterion and to apply a marked-state phase action to solution states while passing non-solution states through an unmarked-state path.

FIG. 5 is a schematic diagram of a recognition diffusion subsystem configured to generate a recognition-weighted state representation, define a weighted reflection axis, and apply a recognition diffusion operation that redistributes amplitude according to a weighting rule that is monotone in a vantage metric.

FIG. 6 is a schematic diagram of a minimal-overhead transform subsystem configured to apply identity treatment to marked solution states, a stronger phase penalty to vantage-likely non-solution states, and a weaker phase penalty to other non-solution states, including binary and continuous-kappa embodiments.

FIG. 7 is a conceptual amplitude-evolution diagram showing comparative behavior of solution-state amplitude, vantage-likely-state amplitude, other-state amplitude, and redirected noise behavior across repeated iterations of a recognition-enhanced quantum search cycle.

FIG. 8 is a schematic diagram of a vantage-metric generation subsystem configured to derive a state-dependent control value from one or more of problem structure, environment-coupling information, Bayesian prior information, learned models, rule-based analyzers, or application-specific feature extractors.

FIG. 9 is a comparative diagram showing binary-kappa and continuous-kappa embodiments, including a binary classification branch, a continuous scoring branch, and phase-control structures for multi-level suppression of non-solution states.

FIG. 10 is a schematic quantum circuit diagram of a recognition-enhanced quantum search implementation including a state register, an ancilla register, a state preparation gate set, an oracle gate block, a kappa-evaluation block, a recognition diffusion gate block, a selective phase-transform gate block, and measurement and feedback paths.

FIG. 11 is a control diagram of adaptive and stroboscopic embodiments showing parameter updating, amplitude estimation, intermediate control feedback, transform-enable logic, iteration scheduling, and stop-condition determination.

FIG. 12 is an application-embodiment diagram showing representative implementations for database search, satisfiability solving, graph optimization, cryptanalysis, and machine-learning hyperparameter search using a common recognition-enhanced quantum search architecture with application-specific vantage-metric sources.

### DETAILED DESCRIPTION OF THE INVENTION

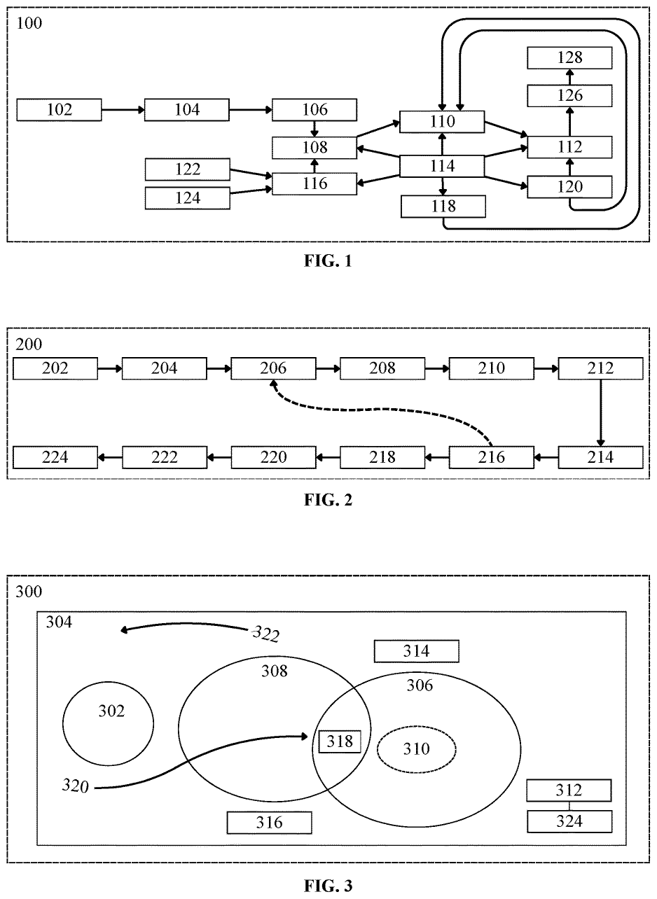

The present disclosure is directed to recognition-enhanced quantum search systems, methods, circuits, control architectures, software implementations, compiler-mediated implementations, simulator-mediated implementations, and hybrid classical-quantum implementations in which a quantum search process is modified to distinguish among multiple categories of candidate states and to apply different machine-level consequences to those categories during iterative amplitude amplification. The description that follows is provided in a continuous narrative format without subsection headings, and each paragraph begins with language intended to make the subject matter of that paragraph readily identifiable for later reference. The drawings are limited to FIGS. 1-12, and the reference numerals used herein correspond to the numeral series assigned to those figures. The disclosed embodiments are illustrative rather than limiting. Features described in connection with one embodiment may be used with other embodiments unless such use is physically incompatible, logically inconsistent, or expressly excluded.

The terms used throughout this detailed description are intended to remain stable across the specification and claims. As used herein, a “candidate state” is any state in a search space under consideration. A “solution state” is a candidate state satisfying a target criterion, whether exactly or according to the satisfaction threshold of a particular embodiment. A “marked state” is a state to which an oracle or analogous target-designation action has been applied. A “non-solution state” is a state not presently designated as satisfying the target criterion. A “vantage-likely state” is a non-solution state that has been classified, estimated, inferred, scored, or otherwise determined to belong to a class that is to receive stronger suppression, stronger de-emphasis, or stronger phase treatment than at least one other class of non-solution states, and in one binary embodiment a candidate state x is assigned to that class when a computed undesirability score S(x) satisfies S(x)≥τ. An “other non-solution state” is a non-solution state that is not in the stronger-suppression class for the embodiment under discussion. An “effective domain” is a practical or operational search burden associated with the portion of the candidate space that remains materially relevant after selective suppression, selective attenuation, or controlled de-emphasis of one or more classes of non-solution states. In representative embodiments, the effective domain is computed as N_eff=N*(1−f_vantage), where f_vantage is a measured or estimated fraction of candidate states assigned to a stronger-suppression class, while in other embodiments the effective domain is computed using a weighted or confidence-adjusted analogue. “Recognition diffusion” refers to a diffusion or diffusion-like operation defined relative to a recognition-weighted state representation rather than only a conventional uniform average state. A “recognition-weighted state representation” comprises a normalized superposition whose weights are computed by a monotone function of the vantage metric. An “objective control input” comprises machine-determined data derived from problem-instance structure, measured or modeled environment coupling, a stored prior distribution, or a deterministic or learned classifier output, and excludes a purely subjective user preference lacking a machine-computable mapping to candidate-state treatment. A “minimal-overhead transform” refers to a transform that applies state-dependent phase or phase-like consequences to different state categories while preserving compatibility with the broader search architecture and while being implementable, in representative embodiments, through diagonal, controlled, multiplexed, or otherwise efficiently realizable transform structures.

The term “classification-confidence,” as used herein, is a machine-computed scalar in a closed interval from 0 to 1 that quantifies reliability of a kappa assignment for a candidate state, a state class, or a state group, and in representative embodiments is computed using at least one objective basis selected from: (i) a classifier margin mapped to the interval [0,1] by a stored normalization rule; (ii) an agreement rate among two or more independent analyzers that each output a kappa classification for the same candidate state, state class, or state group; (iii) a held-out validation accuracy associated with a learned kappa classifier for a same problem family and same feature set; or (iv) a posterior probability generated by a Bayesian model that the candidate state, state class, or state group belongs to the stronger-suppression class. In one non-limiting embodiment, classification-confidence is computed as min(1, |margin|/m0), where margin is a classifier score margin and m0 is a stored normalization constant for the classifier family and operating regime.

The term “basis-dependent noise metric,” as used herein, is a machine-computed scalar that estimates susceptibility of at least one subset of basis states, a state class, or a state group to error during at least one portion of the disclosed oracle marking, kappa evaluation, recognition diffusion, and state-dependent transform cycle, and in representative embodiments is computed from one or more objective inputs selected from: (i) a decoherence-rate estimate derived from a measured T1 or T2 value for qubits used by the search register or ancilla register; (ii) a gate-error estimate for one or more gate families used by the oracle block, kappa evaluation block, recognition diffusion block, or transform block; (iii) a leakage probability estimate or readout bias estimate associated with a basis used by the oracle or transform; or (iv) an environment-coupling score r_env associated with a candidate state, state class, or state group as used in a coverage function. In one non-limiting embodiment, the basis-dependent noise metric is computed as a hardware-profile-weighted sum, noise=a·(1/T2)+b·p_leak+c·p_gate, where a, b, and c are stored weights associated with a selected hardware profile and p_gate is an aggregate of estimated error rates for gates executed in one iteration of the disclosed cycle. In one non-limiting embodiment, transform-enable is asserted when (classification-confidence≥C_min) AND (basis-dependent noise metric≥N_min), where C_min is a stored confidence threshold in a range from 0.6 to 0.9 and N_min is a stored noise threshold associated with a selected hardware profile; otherwise transform-enable is deasserted and the transform is bypassed by setting the transform penalty parameter to zero or omitting the transform block prior to measurement, thereby providing an objective, reproducible rule for the enable-versus-bypass behavior recited in the claims.

The disclosure does not require that every embodiment use identical notation. Nonetheless, several symbols are used consistently herein for clarity. In representative embodiments, phi denotes the golden ratio, beta denotes a transform penalty parameter or transform penalty schedule input, kappa(x) denotes a state-dependent control value or class indicator associated with a candidate state x, N denotes a nominal search-domain size or domain measure, N_eff denotes an effective-domain size or effective-domain measure, f_vantage denotes a fraction or measure associated with states assigned to stronger suppression, w(x) denotes a weighting function, and Z denotes a normalization factor. These quantities are introduced to make the mechanics concrete and reproducible. In claim language and other ASCII-sensitive contexts, phi, beta, tau, and kappa may be expressed in plain-text form to avoid character-set ambiguity without changing meaning. Their use in this description is not intended to exclude mathematically equivalent formulations, rescaled variables, alternative notation, or equivalent representations in a final claim set.

The technical problem addressed by the disclosure can be understood by considering quantum search in practical hardware and practical search domains rather than only in idealized fully unstructured models. In many useful search problems, not all non-solution states are equally undesirable in the same way. Some non-solution states are merely incorrect, while other non-solution states are both incorrect and operationally costly because they sit in conflict-heavy regions, noise-attractive regions, corruption-prone regions, side-channel-sensitive regions, graph-theoretically unfavorable regions, or other regions that a controller would prefer to deprioritize early if a reliable basis for doing so is available. Conventional amplitude-amplification approaches generally do not expose a robust control layer for separating those different classes of non-solution states and then changing the search dynamics accordingly. The present disclosure provides that control layer and does so in a manner that is tied to concrete system components, dataflow behavior, state classification logic, phase-control logic, fallback logic, and measurable operational consequences.

The practical importance of the disclosure is not limited to any one asserted asymptotic improvement statement. Rather, the architecture is useful because it gives the machine objective, machine-actionable mechanisms for determining when a subset of non-solution states should be penalized more strongly than another subset and then carrying out that distinction during iterative search behavior. In some embodiments, the benefit appears as practical reduction in effective search burden. In some embodiments, the benefit appears as more stable behavior under nonuniform noise or environment-coupled disturbance. In some embodiments, the benefit appears as a combination of those effects. In some embodiments, the benefit appears as improved predictability or improved controllability rather than a simple claim of universal speed advantage over an unchanged ideal baseline. The present disclosure is drafted to support those distinctions explicitly.

Turning now to FIG. 1, a recognition-enhanced quantum search system 100 includes a problem instance input 102, a state preparation subsystem 104, an oracle subsystem 106, a recognition diffusion subsystem 108, a minimal-overhead transform subsystem 110, a measurement subsystem 112, a classical controller 114, a kappa generator 116, a transform-penalty selector 118, an effective-domain estimator 120, an environment-model input 122, a Bayesian-prior input 124, a result decoder 126, and an output interface 128. In representative embodiments, system 100 is the top-level architecture that organizes the disclosed search flow. The arrangement shown in FIG. 1 is not limited to one physical packaging or one hardware partition. In different embodiments, one or more of the illustrated components may be implemented in software, firmware, dedicated logic, reconfigurable logic, quantum-circuit logic, a remote service, a local device, or combinations thereof.

The problem instance input 102 receives a machine-processable representation of a search or selection task. In a database-search embodiment, input 102 receives a representation of records, record addresses, indices, or query-constrained candidates. In a satisfiability embodiment, input 102 receives a variable assignment space together with clauses, penalties, or satisfaction conditions. In a graph embodiment, input 102 receives graph nodes, graph edges, paths, cuts, walks, adjacency structures, or graph-derived features. In a cryptanalytic embodiment, input 102 receives a keyspace representation, leakage descriptors, side-channel descriptors, or verification predicates. In a machine-learning embodiment, input 102 receives a hyperparameter domain, candidate-model space, training-policy space, or another model-selection domain. Input 102 may also receive metadata describing hardware constraints, permitted transform depth, acceptable error tolerance, required confidence, or reporting mode. Thus, input 102 is not merely a user-input channel in a presentation sense, but rather a structured ingress point for the machine data needed to define the search problem and to govern how the search is to be performed.

The state preparation subsystem 104 prepares one or more initial states over the candidate domain. In a simple embodiment, subsystem 104 prepares an equal superposition across N candidate states. In a weighted embodiment, subsystem 104 prepares a nonuniform superposition selected according to prior knowledge, structure hints, calibration data, or other control policy, including in one embodiment amplitudes weighted according to a monotone function of the vantage metric or a prior-derived proxy for the vantage metric. In a hybrid embodiment, subsystem 104 receives a preprocessed candidate subset from a classical pre-analysis stage and prepares a state only over that subset. In some embodiments, subsystem 104 also handles qubit allocation, register initialization, ancilla initialization, normalization enforcement, basis selection, or preprocessing needed to align the representation of the problem instance with the representation expected by the oracle subsystem 106 and the recognition diffusion subsystem 108. Subsystem 104 may be implemented by a circuit template, a compiler-generated gate sequence, a simulator state initializer, a hardware-native preparation primitive, or another quantum-state preparation mechanism.

The oracle subsystem 106 applies a target-designation operation to candidate states. In representative embodiments, subsystem 106 identifies a state as a marked state when that state satisfies a solution criterion or a search objective condition. In some embodiments, the criterion is exact, such as equality to a target key or satisfaction of a complete constraint set. In other embodiments, the criterion is threshold-based, such as meeting or exceeding a score, meeting a distance threshold, or satisfying enough but not necessarily all terms in a staged or approximate search regime. Subsystem 106 may therefore implement exact oracle behavior, approximate oracle behavior, staged oracle behavior, or adaptive oracle behavior depending on the embodiment. The important point is that subsystem 106 makes available to the rest of the architecture a concrete distinction between marked and unmarked states, rather than merely describing such a distinction abstractly.

The recognition diffusion subsystem 108 performs a redistribution step that is distinct from a purely conventional unweighted diffusion operation. In representative embodiments, subsystem 108 builds or uses a recognition-weighted state representation influenced by kappa-related information or by a weighting function derived from kappa-related information. In some embodiments, subsystem 108 implements a weighted reflection. In some embodiments, subsystem 108 implements a conventional diffusion kernel together with one or more weighting or bias adjustments that collectively realize the recognition-weighted behavior, including in one embodiment a baseline diffusion block combined with an offset weighting block that approximates a weighted reflection about a recognition-weighted state representation. In some embodiments, subsystem 108 is tuned to reduce reinjection of amplitude into a class of states designated as more undesirable than the remainder of the non-solution space. In some embodiments, subsystem 108 is hardware-aware and may choose among multiple realizations depending on circuit depth, ancilla burden, or expected stability, including in one embodiment selecting between a direct weighted reflection and an approximate baseline-diffusion-plus-offset implementation according to a hardware profile or compiler-estimated resource budget.

The minimal-overhead transform subsystem 110 imposes state-dependent phase or phase-like treatment that distinguishes at least among marked solution states, stronger-suppression non-solution states, and weaker-suppression non-solution states. In representative binary embodiments, subsystem 110 leaves marked states unpenalized, applies a stronger penalty phase to vantage-likely states, and applies a weaker penalty phase to other non-solution states. In representative continuous embodiments, subsystem 110 applies a phase schedule that varies with a continuous or multilevel control value. The phrase “minimal-overhead” does not imply zero cost. Rather, it indicates that the transform is inserted into the search cycle in a way that is compatible with the core architecture and, in representative embodiments, is implementable through diagonal or controlled phase logic without requiring the search process to be redesigned from scratch.

The measurement subsystem 112 performs readout at an appropriate point in the process. In some embodiments, subsystem 112 performs a final measurement only after the stop criterion has been satisfied. In some embodiments, subsystem 112 also participates in intermediate observation routines or calibration runs, including in one embodiment a calibration run used to estimate whether a transform-enabled mode or a transform-bypassed mode is more stable under current hardware conditions. In some embodiments, subsystem 112 produces a raw basis-state readout. In some embodiments, subsystem 112 produces one or more statistics, confidence scores, or distributional indicators, including in one embodiment a comparison metric indicating whether a transform-enabled mode or a transform-bypassed mode produced a more stable marked-state signal under current hardware conditions. In some embodiments, subsystem 112 is constrained by a reporting policy that distinguishes between internal controller-facing observations and external user-facing output. In this respect, subsystem 112 can participate both in algorithm execution and in audit, benchmarking, or verification behavior.

The classical controller 114 coordinates the operation of the illustrated system. In representative embodiments, controller 114 receives the problem definition through input 102, governs the preparation of the initial state through subsystem 104, schedules oracle and transform operations, receives kappa-related information from generator 116, receives transform-penalty information from selector 118, monitors effective-domain information from estimator 120, and decides when to continue, adapt, attenuate, bypass, or stop the search. Controller 114 may be implemented as a general-purpose processor executing software, as dedicated control logic, as firmware, as a workflow engine, as a cloud-service scheduler, or as a hybrid arrangement. The controller may also maintain execution logs, parameter histories, regime decisions, and results metadata to support reproducibility and later validation, including in one embodiment storing a reason code indicating whether transform-enabled operation, transform attenuation, or transform bypass was selected for a given iteration or phase. Controller 114 is therefore a substantive component of the invention and not merely a generic host processor.

The kappa generator 116 produces one or more control values that characterize candidate states, state classes, subspaces, or search regions for purposes of stronger or weaker suppression. In some embodiments, generator 116 outputs a binary value such as kappa(x) in {0,1}. In some embodiments, generator 116 outputs a multi-level or continuous value. In some embodiments, generator 116 also outputs confidence information indicating how reliable the current kappa assignment is, including in one embodiment a confidence score derived from classifier margin, agreement among multiple analyzers, historical validation accuracy, or combinations thereof. In some embodiments, generator 116 receives information from environment-model input 122 and Bayesian-prior input 124 and combines those signals with problem-structure-derived features. In some embodiments, generator 116 is static over a search run. In some embodiments, generator 116 is updated periodically or adaptively, including in one embodiment at a phase boundary, after an intermediate estimation event, or after a controller-detected change in estimated noise or classification confidence. The architecture therefore supports both fixed and evolving state classification.

The selector 118 supplies one or more transform-penalty parameters or transform schedules. In a simple embodiment, selector 118 outputs a fixed transform penalty parameter chosen before search execution begins, subject in some embodiments to later controller-enforced clipping, smoothing, or bounded adjustment under changing estimated noise or classification-confidence conditions. In a more dynamic embodiment, selector 118 provides a transform penalty parameter that changes over time, over iterations, or over search phases, including in one embodiment decreasing the transform penalty parameter when classification confidence falls below a threshold or when estimated noise exceeds a threshold. In still other embodiments, selector 118 outputs not just a scalar transform penalty parameter but a policy describing how the transform penalty parameter is to vary with classification confidence, observed noise, iteration index, or a convergence estimate, including in one embodiment decreasing the transform penalty parameter when classification confidence falls below a threshold or when estimated noise exceeds a threshold. Selector 118 may also enforce bounds, clipping, smoothing, quantization, or hardware-specific constraints, including limiting transform penalty parameter updates to remain within a hardware-supported phase range while preserving a stronger penalty for the first class of non-solution candidate states than for the second class. Thus, selector 118 supports both narrow embodiments with fixed transform parameters and broader embodiments with dynamic transform control.

The effective-domain estimator 120 determines, estimates, predicts, or scores the practical search burden associated with the portion of the domain that remains materially relevant after stronger suppression of a subset of non-solution states. In some embodiments, estimator 120 computes N_eff from a fraction f_vantage using a relationship such as N_eff=N*(1−f_vantage). In some embodiments, estimator 120 computes N_eff using a more general score that accounts for confidence, weighting, hardware conditions, or continuous-valued classification. In some embodiments, estimator 120 supplies its output to controller 114 for deciding how many iterations to schedule, whether to enable the transform, or whether to revert to a fallback mode, including by comparing an iteration budget computed from the effective-domain estimate with a baseline iteration budget computed from a nominal domain size and enabling the transform when the effective-domain-based budget indicates a practical reduction in search burden. In some embodiments, estimator 120 is used primarily for analysis and benchmarking rather than control, including benchmarking transform-enabled operation against bypassed operation under different estimated noise and classification-confidence conditions. The disclosure therefore supports both operational and non-operational uses of effective-domain estimation.

The environment-model input 122 supplies information about noise, decoherence, leakage, crosstalk, basis-dependent vulnerability, or other environment-coupled effects. In some embodiments, input 122 is derived from hardware characterization data. In some embodiments, input 122 is learned from prior runs. In some embodiments, input 122 is modeled analytically or heuristically, including in one embodiment by assigning basis-state or state-class noise-risk scores used in determining whether transform-enabled operation is likely to improve robustness relative to bypassed operation. In some embodiments, input 122 is absent, in which case the system can still operate based on problem-structure information alone. The Bayesian-prior input 124 supplies prior distributions, ranked hypotheses, learned probabilities, or other prior-based guidance. In some embodiments, input 124 identifies a region more likely to contain a solution, and in some embodiments input 124 is also used to identify a region more likely to be undesirable for purposes of kappa generation, transform-enable control, or initial weighting selection. In some embodiments, input 124 identifies a region more likely to be undesirable. In some embodiments, input 124 is used only to bias kappa generation rather than directly to bias amplitude preparation, and in some embodiments a controller selectively permits prior-biased amplitude preparation only when the prior information satisfies a confidence or freshness criterion. These distinctions are useful because they separate prior information as a source of control from prior information as a direct state-preparation bias.

The result decoder 126 converts measured outcomes into usable answers. In some embodiments, decoder 126 maps a basis-state outcome to a database record identifier, a satisfying assignment, a graph structure, a key candidate, or a hyperparameter set. In some embodiments, decoder 126 also performs post-measurement validation, including in one embodiment validating a measured candidate against the target criterion and associating the validation result with stored execution metadata including a selected transform penalty parameter value, a selected kappa policy, and a transform-enable or transform-bypass state. In some embodiments, decoder 126 distinguishes between a raw candidate and a verified candidate. In some embodiments, decoder 126 outputs both a human-readable answer and a machine-actionable answer. In some embodiments, decoder 126 preserves provenance data, parameter data, or execution-history data alongside the decoded result. The output interface 128 then provides the resulting information to a downstream system, a user interface, a remote service, a storage layer, or a control loop. The distinction between decoding and output is maintained because a decoded answer and a final emitted output need not be identical in form or scope.

FIG. 1 therefore represents a complete top-level system architecture in which the disclosed search method is not merely a mathematical operation but a coordinated flow of structured inputs, search-state preparation, state classification, weighted amplitude redistribution, selective transform application, measurement, decoding, and output. That architecture supports claims directed to method, system, device, compiler, service, and hybrid embodiments because the components of the architecture can be allocated differently while preserving the same core behavior.

Turning now to FIG. 2, a recognition-enhanced quantum search process 200 includes loading a problem instance at 202, preparing an initial superposition at 204, applying oracle marking at 206, evaluating or retrieving kappa at 208, applying recognition diffusion at 210, applying the minimal-overhead transform at 212, incrementing an iteration counter at 214, determining a stop criterion at 216, optionally updating a transform penalty parameter and/or kappa at 218, measuring a state at 220, decoding the result at 222, and outputting a solution at 224. FIG. 2 provides a process-level complement to the system-level architecture of FIG. 1. The steps shown in FIG. 2 are exemplary and may be combined, reordered in non-core respects, or implemented across different processing locations so long as the disclosed search-control logic is preserved.

Loading the problem instance at 202 includes ingesting and normalizing the data necessary to define the search. In a database embodiment, this may include candidate identifiers, indexing structures, corruption or reliability features, and a solution verification rule. In a satisfiability embodiment, this may include variables, clauses, and conflict metrics. In a graph embodiment, this may include adjacency structures, cost functions, or structural descriptors. In a cryptanalytic embodiment, this may include a keyspace, a verification routine, and optional leakage descriptors. In a machine-learning embodiment, this may include a hyperparameter domain, a validation objective, and one or more indicators of poor expected generalization. Step 202 may also include translating the original problem into a representation more suitable for quantum-state preparation and oracle evaluation. For example, step 202 may allocate bits, qubits, indices, reversible comparators, or lookup structures. Accordingly, step 202 is not merely receiving a file or request; it may also perform encoding, normalization, domain reduction, consistency checks, or resource planning.

Preparing the initial superposition at 204 includes generating the search-ready quantum state. In a baseline embodiment, step 204 prepares a substantially equal superposition across the candidate space. In other embodiments, step 204 prepares a weighted superposition, such as where prior information indicates that certain regions deserve more or less initial amplitude, including in one embodiment amplitudes weighted according to a monotone function of the vantage metric or a prior-derived proxy for the vantage metric. In still other embodiments, step 204 prepares a superposition over a pre-pruned or pre-ranked subset, for example where a classical preprocessing stage has already excluded states that need not be searched at all. In some embodiments, step 204 also prepares ancilla states or control-register states needed for later kappa evaluation or transform routing, including in one embodiment ancilla states initialized to store class indicators, scores, or thresholds derived from classical preprocessing for later use in kappa evaluation or transform-enable decisions. Step 204 may also include sanity checks, calibration operations, or normalization operations. In some embodiments, step 204 is compile-time determined. In some embodiments, step 204 is selected dynamically based on the problem instance and available hardware constraints. The disclosure therefore supports both a simple equal-superposition embodiment and more advanced embodiments in which initialization itself reflects structure-aware control policy.

Applying oracle marking at 206 includes identifying states satisfying a target condition and applying a corresponding marking consequence. In representative embodiments, the oracle action is a phase inversion on states satisfying a search predicate. In other embodiments, the oracle action may include a different phase encoding, a flagging action, or an ancilla-mediated indication that a state is in a target class. Step 206 can be exact or approximate. In a strict verification embodiment, only states satisfying the complete solution condition are marked. In a staged embodiment, step 206 may mark states satisfying a partial criterion during an early phase and a stricter criterion in a later phase. This allows the architecture to support progressive narrowing, coarse-to-fine search, or hardware-aware simplifications. The invention is therefore not limited to a single exact oracle style, although standard exact marking remains a useful embodiment.

Evaluating or retrieving kappa at 208 includes obtaining the state-dependent control value used to govern stronger or weaker suppression. Step 208 may involve computing kappa from problem features, retrieving previously computed kappa values from memory, receiving kappa from a classical pre-analysis stage, or combining multiple information sources into a single control metric. In some embodiments, kappa is binary. In some embodiments, kappa is continuous. In some embodiments, kappa is attached to each state individually. In some embodiments, kappa is attached to clusters, regions, equivalence classes, or encoded state descriptors. In some embodiments, step 208 also produces confidence measures, thresholds, or transformation-policy suggestions, including in one embodiment a recommendation to switch between binary-kappa and continuous-kappa operation according to estimated noise, classification confidence, or hardware-depth limits. Step 208 can occur every iteration, every kth iteration, once before the search begins, once before a search phase begins, or on-demand when controller 114 determines that an update is justified. The optionality and timing of step 208 are therefore expressly supported rather than assumed away.

Applying recognition diffusion at 210 includes redistributing amplitude in a recognition-aware manner. This step differs from a conventional uniform diffusion step because the reflection axis or effective redistribution behavior depends on state-category information or a weighting derived therefrom. In some embodiments, step 210 performs a direct weighted reflection about a state |psi_kappa>. In some embodiments, step 210 uses an equivalent or approximate construction that produces similar redistribution behavior with fewer resources. In some embodiments, step 210 is designed so that states more likely to be strongly penalized in step 212 are already treated differently before the transform occurs. In other embodiments, step 210 is deliberately more modest and the stronger distinction is deferred to step 212. These variants support both broader claims directed to a general recognition diffusion stage and narrower claims directed to specific weighted-reflection implementations.

Applying the minimal-overhead transform at 212 includes applying a category-dependent phase schedule or analogous transform schedule, including in some embodiments using an ancilla register and one or more controlled-phase gates, and including in some embodiments applying the transform every iteration or every kth iteration according to a stroboscopic schedule. In representative embodiments, marked states receive identity treatment, vantage-likely non-solution states receive a stronger penalty, and other non-solution states receive a weaker penalty, with representative implementations using different phase treatments for the respective non-solution classes. In binary embodiments, these may be two discrete penalty classes. In continuous embodiments, there may be a continuum or multilevel ladder of penalties. Step 212 may be performed every iteration, periodically, adaptively, or only in selected search phases. Step 212 may also be partially bypassed, attenuated, or clipped when hardware constraints require a softer transform. The process flow of FIG. 2 is therefore drafted to support both strict per-iteration transform embodiments and broader adaptive or stroboscopic embodiments.

Incrementing the iteration counter at 214 serves more than bookkeeping. In some embodiments, the counter is used to enforce a predetermined iteration budget. In some embodiments, the counter governs a stroboscopic transform schedule, such as applying the transform every kth iteration. In some embodiments, the counter is part of a controller policy that changes a transform penalty parameter or kappa after an initial pruning phase. In some embodiments, the counter is recorded in an audit log, including in one embodiment together with a then-current transform penalty parameter value, a then-current kappa policy, and a transform-enable or transform-bypass state. In some embodiments, the counter determines when to perform intermediate estimation or intermediate observation, including in one embodiment by triggering an intermediate estimation routine every kth iteration or at a selected iteration window associated with a stroboscopic transform schedule. Thus, step 214 supports time-varying control policies and is not limited to a trivial loop variable.

Determining a stop criterion at 216 includes deciding whether the search should continue, stop, or transition to a different operating mode, and in one non-limiting embodiment the stop criterion is satisfied when an amplitude estimate for a marked subspace satisfies a confidence threshold of at least 0.8 or when an iteration budget computed from an effective-domain estimate N_eff is exhausted, whichever occurs first. In one embodiment, the stop criterion is a fixed iteration count derived from a projected domain size or effective-domain estimate. In another embodiment, the stop criterion uses an amplitude estimate or convergence proxy. In another embodiment, the stop criterion depends on a hardware-depth budget, an error budget, a confidence threshold, or a controller rule. In yet another embodiment, the stop criterion distinguishes between “continue with current mode,” “continue with an altered transform penalty parameter,” “continue with transform bypass,” and “measure now.” Thus, step 216 can support multi-branch control outcomes, not only a binary stop/go decision.

In one non-limiting satisfiability embodiment, a candidate state x represents a Boolean assignment, an undesirability score S(x) is computed as a clause-violation count for x, and a binary kappa classification is assigned as kappa(x)=1 when S(x)≥τ and kappa(x)=0 otherwise, with τ being a stored threshold, such as τ=3 for a representative clause set. In this embodiment, classification-confidence is computed as an agreement rate between two analyzers that each produce a kappa assignment for x, including a clause-violation analyzer and a clause-proximity analyzer, and in a representative run the agreement rate is 0.8, yielding classification-confidence=0.8. In this embodiment, a basis-dependent noise metric is computed from a measured T2 value and a leakage estimate for gates used by the oracle and transform blocks, and transform-enable is asserted when classification-confidence≥0.7 and the basis-dependent noise metric exceeds a stored threshold N_min associated with a hardware profile. When transform-enable is asserted, a transform penalty parameter β is selected from a stored range and the transform is applied every kth iteration with k being an integer, such as k=2 in a representative stroboscopic schedule, and an effective-domain estimate is computed as N_eff=N·(1−f_vantage) using a measured fraction f_vantage of states assigned kappa=1, thereby providing an end-to-end example of objective kappa computation, objective enable/bypass gating, effective-domain estimation, and iteration planning.

Optionally updating a transform penalty parameter and/or kappa at 218 supports adaptive embodiments. In some embodiments, a transform penalty parameter is increased as stronger suppression becomes justified. In some embodiments, a transform penalty parameter is decreased when the controller detects rising instability or low classification confidence, including in one embodiment when estimated noise exceeds a threshold or when classification confidence falls below a threshold. In some embodiments, kappa is recomputed based on new data, intermediate estimates, changed priors, or revised environment information. In some embodiments, neither the transform penalty parameter nor kappa is changed, and step 218 simply passes through. In some embodiments, step 218 also updates thresholds, transform schedules, or the choice between binary and continuous modes. The optionality of step 218 is significant for claim drafting because it distinguishes fixed-parameter embodiments from adaptive embodiments without forcing either mode to be universal.

Measuring the state at 220, decoding the result at 222, and outputting the solution at 224 together define the termination and reporting portion of the process. Step 220 may involve full measurement, partial measurement, or a selected readout strategy, including in one embodiment a readout strategy selected according to a remaining measurement budget, an estimated convergence level, or a controller determination that transform-enabled operation remains justified. Step 222 converts the measured outcome into an application-domain answer, optionally together with validation, ranking, or metadata attachment. Step 224 emits the answer or makes it available to a consuming entity. The process therefore supports not only execution but also result packaging, validation, and interface behavior. This is helpful because later claims may distinguish between search logic, validation logic, and output logic.

FIG. 2 also supports several fallback behaviors. If the controller determines that kappa is unavailable, insufficiently informative, or too costly to maintain, step 208 may output a neutral value or a bypass instruction. If the controller determines that transform cost outweighs expected benefit, step 212 may be bypassed or attenuated. If the controller determines that the regime is effectively unstructured, then the process can reduce to a standard Grover-like loop by selecting a no-op transform or setting a transform penalty parameter to zero. Thus, fallback behavior is part of the process disclosure itself, not an afterthought.

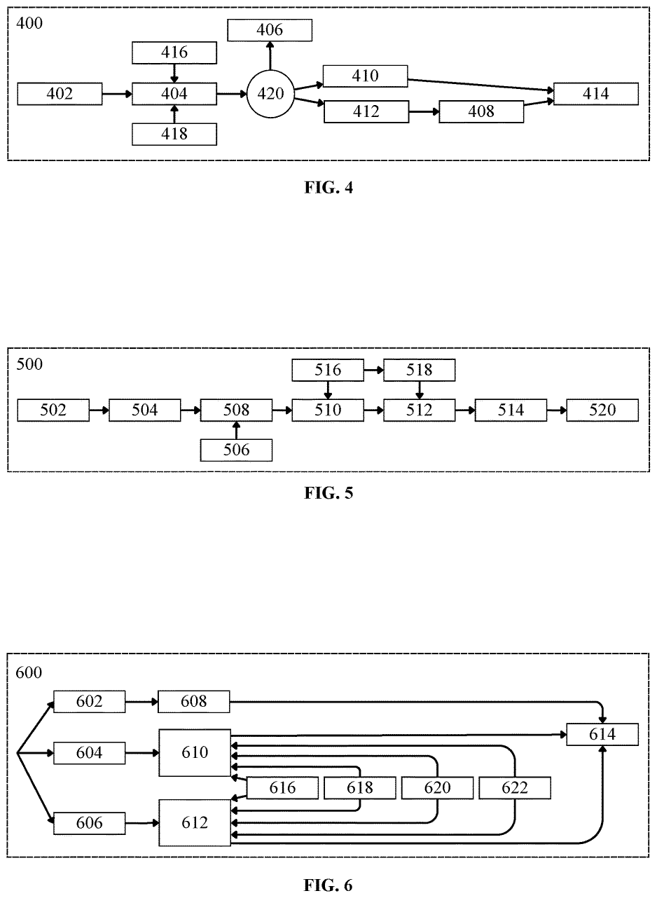

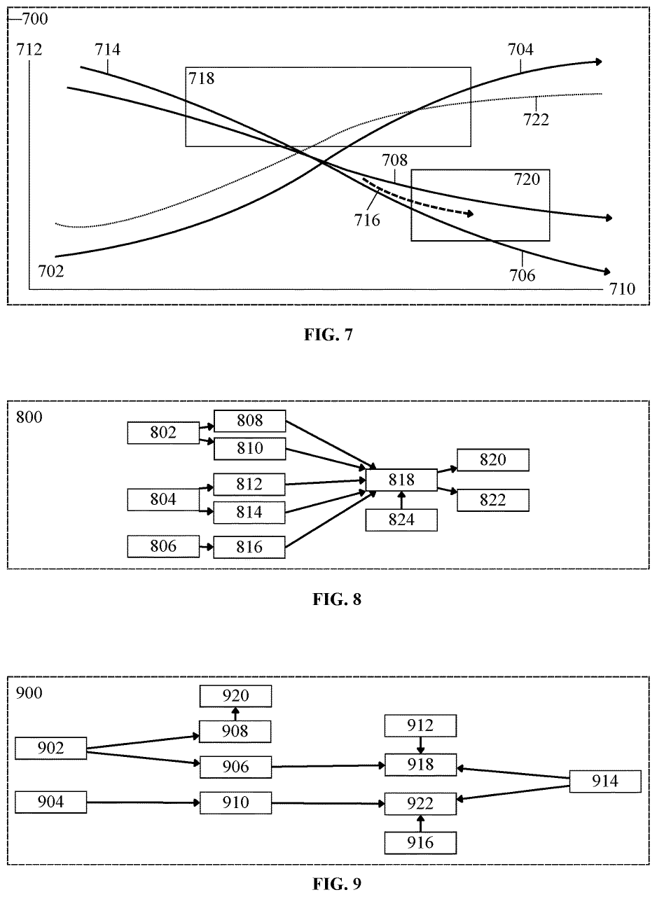

Turning now to FIG. 3, a search-space partition 300 includes a solution subset 302, a non-solution subset 304, a vantage-likely subset 306, an other-state subset 308, a suppressed or pruned subset 310, an effective domain N_eff 312, a kappa=1 region 314, a kappa=0 region 316, an intermediate-kappa region 318, a noise trajectory 320, a protected solution trajectory 322, and a pruning fraction f_vantage 324. FIG. 3 is useful because it makes explicit that the disclosed architecture acts not just on “solutions” versus “non-solutions,” but on a finer-grained partition of the non-solution space.

The solution subset 302 includes one or more states that satisfy the target condition for the current search regime. The non-solution subset 304 includes states that do not satisfy that target condition. Within non-solution subset 304, the vantage-likely subset 306 includes states assigned to stronger suppression, and the other-state subset 308 includes states assigned to weaker suppression or otherwise differentiated treatment. In some embodiments, suppressed or pruned subset 310 corresponds substantially to vantage-likely subset 306. In other embodiments, suppressed or pruned subset 310 is a result-oriented designation referring to states whose practical influence is reduced over time through the combined effect of recognition diffusion and the transform, whether or not they were initially assigned a binary stronger-suppression label, including in one embodiment states assigned intermediate kappa values that accumulate reduced amplitude across repeated iterations without being placed in an initial binary strongest-suppression class. This flexibility is important because suppression can be defined by controller intent, by transform parameters, by observed amplitude behavior, or by a practical effect on the search burden.

The effective domain N_eff 312 is intentionally broader than a mere literal set-cardinality count. In some embodiments, N_eff is an integer count of states not assigned to the strongest suppression class. In other embodiments, N_eff is a weighted effective size derived from the distribution of kappa values, the strength of suppression, classification confidence, or hardware conditions. In still other embodiments, N_eff is treated as an operational measure of burden rather than a strict count. This flexibility supports a broad range of analyses and implementations while remaining technically meaningful. A later claim may recite an effective-domain estimate, effective-domain determination, or effective-domain-controlled iteration schedule without forcing the specification to a single narrow mathematical definition.

The kappa=1 region 314 and kappa=0 region 316 represent binary embodiments. The intermediate-kappa region 318 represents multilevel or continuous embodiments. In a binary implementation, the controller may use only regions 314 and 316. In a continuous implementation, region 318 may be substantial and can be used to generate graduated phase treatments rather than just two discrete penalties. In a hybrid embodiment, states may first be scored continuously, then bucketed into two or more classes. The disclosed invention supports all of these modes and expressly separates the classification source from the classification consequence. A score alone is not the invention. A score that is operationalized through the disclosed control architecture is.

The noise trajectory 320 and protected solution trajectory 322 clarify a further aspect of the architecture. In some embodiments, hardware or environment effects are not uniform across the search space. Certain states or state classes may be more likely to absorb noise, leakage, or decoherence. When such information is available or inferable, the controller can classify those states as vantage-likely and thus arrange for them to receive stronger suppression. The protected solution trajectory 322 conceptually captures the effect of keeping useful solution-directed behavior more stable by steering the dynamics away from states already judged undesirable. The disclosure does not require that every implementation measure or draw a literal trajectory, but it does support systems and methods designed around that control objective.

The pruning fraction f_vantage 324 denotes the fraction or measure associated with the stronger-suppression class. In a binary embodiment, f_vantage may be a fraction of states assigned kappa=1. In a continuous embodiment, f_vantage may be derived from a thresholded or weighted measure over kappa values. In some embodiments, f_vantage is computed prior to search execution. In some embodiments, f_vantage is updated adaptively. In some embodiments, f_vantage is used by effective-domain estimator 120 to project iteration count or to decide whether the transform should be enabled. The explicit inclusion of f_vantage 324 therefore helps support claims drawn to thresholding, pruning, effective-domain control, or break-even determination.

Turning now to FIG. 4, an oracle marking subsystem 400 includes a candidate state input 402, a solution criterion evaluator 404, a marked-state output 406, a phase flip element 408, an unmarked-state pass-through path 410, a marked-state phase-inverted path 412, an oracle output state 414, a condition register 416, a problem constraint input 418, and a match decision node 420. The oracle subsystem is described at a finer level here than in FIG. 1 so that the specification supports both system-level and circuit-level claims.

The candidate state input 402 receives a candidate basis state or an encoded representation thereof. In some embodiments, the candidate state input is a state on a quantum register. In some embodiments, it is a simulator representation of such a state. In some embodiments, the input is accompanied by one or more ancilla values, flags, indices, or temporary descriptors. The condition register 416 stores the target condition used by evaluator 404. In a key search, that condition may be a target key or verification rule. In satisfiability, it may be a clause set or a sufficient satisfaction rule. In graph search, it may be a target structure or cost threshold. In model selection, it may be an evaluation criterion or surrogate acceptance rule. Thus, the condition register need not be a single exact comparator target; it can encode more general decision logic.

The solution criterion evaluator 404 compares the current candidate against the condition embodied in condition register 416 and any further information supplied by problem constraint input 418. Problem constraint input 418 may include static problem structure, side data, thresholds, or rule parameters. The match decision node 420 then decides whether the candidate is to be treated as a marked state. If the criterion is not met, the candidate follows unmarked-state pass-through path 410. If the criterion is met, the candidate follows marked-state phase-inverted path 412, and phase flip element 408 applies the corresponding phase consequence. Oracle output state 414 carries the result onward in the search flow, and marked-state output 406 may provide an auxiliary indication for controller, logging, or adaptive use.

The oracle subsystem of FIG. 4 supports several alternatives. In an exact embodiment, evaluator 404 uses a reversible decision routine that precisely identifies solution states. In an approximate embodiment, evaluator 404 identifies states that are predicted to be solutions or near-solutions. In a staged embodiment, evaluator 404 initially marks states satisfying a relaxed condition and later marks states satisfying a stricter condition. In a threshold embodiment, evaluator 404 marks states with score above or below a selected threshold. In a learned embodiment, evaluator 404 uses a learned or synthesized scoring function compiled into a reversible comparison routine. The invention therefore supports a wide range of oracle behaviors, and the later claim set may choose to recite an exact oracle or a more general target-designation stage.

Turning now to FIG. 5, a recognition diffusion subsystem 500 includes a weighted-state input 502, a weight function w(x) 504, a normalization factor Z 506, a weighted superposition psi_kappa 508, a reflection axis 510, a reflection operator block 512, a reflected output 514, a baseline diffusion block 516, an offset weighting block 518, and a solution-biased output 520. The purpose of FIG. 5 is to make clear that the disclosed search does not rely solely on a conventional diffusion step that ignores the state-category structure available to the system. The weight function w(x) 504 is defined so that it is monotone in kappa(x) in representative embodiments. The direction of monotonicity can depend on implementation convention. In some embodiments, a higher kappa means stronger phase suppression later and correspondingly different weighting now. In some embodiments, the weighting is arranged to deemphasize vantage-likely states already at the diffusion stage. In other embodiments, the weighting is arranged to structure the reflection axis in a way that makes the subsequent transform more effective. The key feature is that w(x) is not arbitrary but is functionally tied to the state-category metric or an operational proxy for that metric.

The normalization factor Z 506 ensures that the weighted superposition psi_kappa 508 is normalized or properly scaled. In some embodiments, Z is the sum of weights. In some embodiments, Z is derived from a weighted norm. In some embodiments, Z is approximated or bounded to reduce hardware cost, including in one embodiment by using a bucketed or piecewise approximation to a normalization factor associated with groups of candidate states sharing a common or similar kappa range. The reflection axis 510 is then built from psi_kappa 508, and reflection operator block 512 performs the corresponding reflection or reflection-like redistribution. In some embodiments, reflected output 514 is immediately sent onward to the transform stage. In some embodiments, reflected output 514 is logged, estimated, or further processed, including in one embodiment to derive a redistribution-quality indicator used by controller 114 to retain, attenuate, or bypass the transform in a subsequent iteration or phase. The solution-biased output 520 denotes the practical effect of using a recognition-weighted diffusion rule rather than a purely unweighted one.

Baseline diffusion block 516 and offset weighting block 518 support an important class of embodiments. In some implementations, a full direct weighted reflection may be costly or inconvenient to realize. In those cases, a standard or near-standard diffusion block may be used together with one or more weighting adjustments so that the combined behavior approximates or realizes the intended recognition diffusion. This supports hardware-efficient, compiler-efficient, and simulator-efficient embodiments without forfeiting the architectural distinction that the diffusion behavior is recognition-aware. The disclosure is therefore not limited to one exact gate decomposition of the diffusion stage.

Turning now to FIG. 6, a minimal-overhead transform subsystem 600 includes a marked-state branch 602, a vantage-likely branch 604, an other-state branch 606, an identity phase on marked branch 608, a strong penalty phase 610, a mild penalty phase 612, an output combiner 614, a transform-penalty input 616, a phi ratio constraint 618, a continuous-kappa phase rule 620, and a kappa_max normalizer 622. FIG. 6 is the figure that most directly supports the selective transform aspect of the invention.

The marked-state branch 602 receives states currently designated as marked or solution states, and the branch is configured to preserve identity treatment for those states during application of the transform. In representative embodiments, identity phase on marked branch 608 ensures that the minimal-overhead transform does not penalize those states. This supports the disclosed distinction between solution-directed amplification and non-solution suppression. The vantage-likely branch 604 receives states in the stronger-suppression class, and strong penalty phase 610 applies a correspondingly stronger phase treatment. The other-state branch 606 receives non-solution states in a weaker-suppression class, and mild penalty phase 612 applies a weaker phase treatment in representative phi-based binary embodiments. Output combiner 614 then recombines these branches into the transformed state.

The transform-penalty input 616 can be fixed or variable, including in some embodiments being decreased when classification confidence falls below a threshold or when estimated noise exceeds a threshold. In a simple embodiment, a transform penalty parameter is selected before execution and remains constant. In a more adaptive embodiment, the transform penalty parameter changes with iteration index, environment conditions, classification confidence, convergence estimate, or controller policy. The phi ratio constraint 618 represents embodiments in which the relative strength of the strong and mild penalties is governed by phi. This can be exact in some embodiments and approximate in others. Continuous-kappa phase rule 620 supports implementations where the transform is not just binary but instead depends on a graded state-quality metric. Kappa_max normalizer 622 supports normalized scaling of the continuous schedule. The specification therefore supports a broad set of claims ranging from specific binary phi-ratio embodiments to broader continuous-transform embodiments.

The transform of FIG. 6 can be implemented in multiple ways. In one implementation, the transform is a diagonal unitary in the computational basis. In another implementation, the transform is realized through controlled-phase gates driven by a classification ancilla. In another implementation, the transform is multiplexed based on a bucketized or encoded kappa value. In another implementation, the transform is synthesized from a compiler-level description rather than hand-specified. In another implementation, the transform is approximated for lower depth or lower resource cost, including by discretizing a continuous-kappa phase schedule into a finite bucketed schedule implemented with fewer controlled-phase operations. These alternatives matter because examiner scrutiny often focuses on whether a transform is merely described functionally or is actually supported by implementable structure. FIG. 6 and the accompanying narrative support concrete implementations.

Turning now to FIG. 7, an amplitude evolution model 700 includes an initial amplitude distribution 702, a solution amplitude curve 704, a vantage-likely amplitude curve 706, an other-state amplitude curve 708, an iteration axis 710, an amplitude axis 712, a noise input 714, a redirected noise path 716, a protected solution region 718, a convergence region 720, and a standard Grover comparison curve 722. This figure is conceptual, but it is important to the technical disclosure because it explains the intended operational effect of the architecture.

Initial amplitude distribution 702 represents the pre-iteration or early-iteration distribution. Solution amplitude curve 704 represents how amplitude associated with marked or solution states evolves. Vantage-likely amplitude curve 706 represents how amplitude associated with stronger-suppression states evolves. Other-state amplitude curve 708 represents how amplitude associated with weaker-suppression non-solution states evolves. Noise input 714 represents one or more disturbances that may affect the search. Redirected noise path 716 indicates the design objective that disturbance should, to the extent achievable, be directed into states already designated as less desirable rather than interfering with solution-directed evolution indiscriminately. Protected solution region 718 represents a region in which useful search dynamics are comparatively more stable. Convergence region 720 represents a region in which readout becomes operationally beneficial. Standard Grover comparison curve 722 provides a baseline reference.

The disclosure expressly avoids overstating this figure. FIG. 7 does not imply that the disclosed method universally outperforms ideal standard Grover on the same unchanged fully unstructured domain. Rather, it supports the more careful proposition that the invention can provide value in structured or partially structured regimes, in nonuniform noise regimes, in regimes where a meaningful stronger-suppression class exists, or in regimes where controller predictability matters. This is important for prosecution because it grounds the technical advantage in the disclosed architecture rather than in an overbroad theoretical assertion.

Turning now to FIG. 8, a kappa generation subsystem 800 includes a problem-structure input 802, an environment-coupling model input 804, a Bayesian-prior input 806, a constraint-density analyzer 808, a graph-degree analyzer 810, a clause-proximity analyzer 812, a leakage-pattern analyzer 814, a hyperparameter-generalization analyzer 816, a kappa score output 818, a binary threshold block 820, a continuous scoring block 822, and a stored heuristic table 824. FIG. 8 is particularly important for enablement and written-description support because it explains where the state-quality information comes from and how it becomes machine-actionable.

Problem-structure input 802 supplies features that are inherent to the search task. For example, in satisfiability, such features may include conflict counts, partial-satisfaction counts, or clause-weight structure. In graph problems, such features may include node degree, centrality, subgraph signature, edge participation, or cut-related metrics. In database search, such features may include corruption tags, reliability indicators, address locality, or query-derived structure. Environment-coupling model input 804 supplies information about how noise or hardware effects interact with states or classes of states. Bayesian-prior input 806 supplies prior likelihoods or ranking information. Constraint-density analyzer 808, graph-degree analyzer 810, clause-proximity analyzer 812, leakage-pattern analyzer 814, and hyperparameter-generalization analyzer 816 are representative analysis components that convert these inputs into a score or class-relevant signal.

The kappa score output 818 is a significant boundary in the architecture. Before output 818, the system is analyzing data. After output 818, the system has a machine-actionable control value that can be used to alter search dynamics. Binary threshold block 820 supports embodiments in which the score is mapped into discrete classes. Continuous scoring block 822 supports embodiments in which the score is preserved or transformed into a continuous or multilevel control signal. Stored heuristic table 824 supports implementations using lookup logic, previously learned associations, rule-based mappings, calibration values, or empirically derived operating points. The presence of stored table 824 is useful because it supports embodiments in which the classification logic is not computed from scratch every time but is instead drawn from maintained operational knowledge.

The subsystem of FIG. 8 supports many controller policies. In one policy, the controller uses only problem-structure-derived inputs. In another, it uses only environment-derived inputs. In another, it combines multiple sources. In one policy, if confidence in output 818 is low, the controller widens the weaker-suppression class or disables the transform. In another, if confidence is high, the controller enables stronger transform action, including in one embodiment by enabling the transform when classification confidence satisfies a threshold and an effective-domain estimate indicates a practical reduction in search burden relative to a nominal-domain baseline. In another, the controller starts with binary thresholding, then later switches to continuous scoring as more information becomes available. These alternatives are explicitly supported so that later claims may recite particular kinds of kappa sourcing, thresholding, or controller use.

Turning now to FIG. 9, a kappa embodiment selector 900 includes a binary-kappa branch 902, a continuous-kappa branch 904, a high-kappa state group 906, a low-kappa state group 908, an intermediate-kappa state group 910, a coverage function F_cov(r) 912, a coupling metric r_env 914, an X_opt parameter 916, a multi-level phase gate 918, a binary phase gate 920, and a continuous phase schedule 922. The binary-kappa branch 902 is well suited to hardware-efficient embodiments, to easier explainability, and to simpler transform control. The continuous-kappa branch 904 is well suited to finer-grained state discrimination. High-kappa state group 906, low-kappa state group 908, and intermediate-kappa state group 910 collectively show that the disclosure supports not just two categories but graded or bucketed classifications.

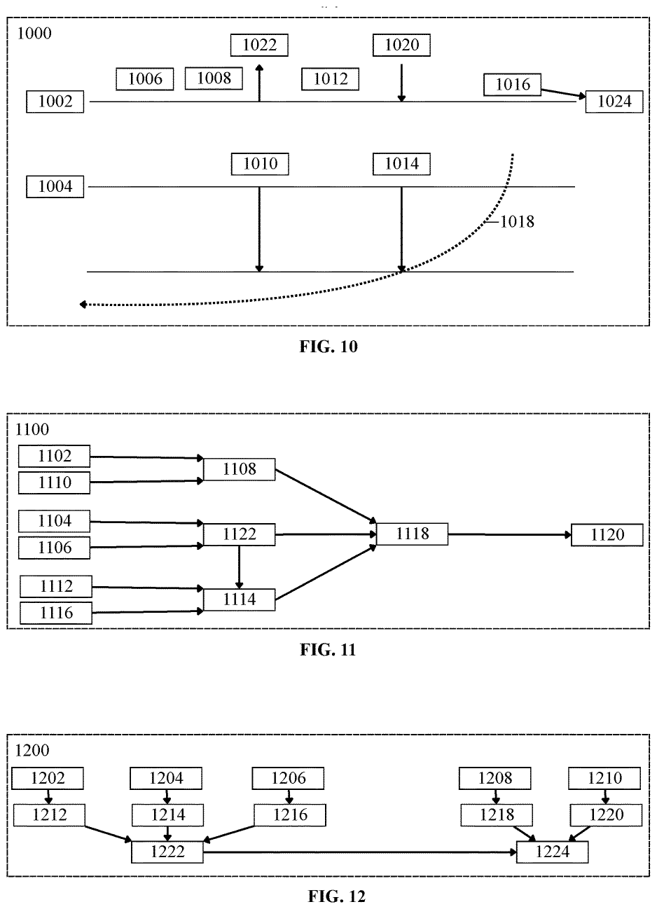

The coverage function F_cov(r) 912 and the coupling metric r_env 914 support embodiments in which kappa is derived from or related to a coupling measure, and in ASCII-sensitive contexts the coverage function may be expressed in descriptive terms as a monotone normalized function of the coupling measure and an operating-point parameter. In representative embodiments, the coverage function may take a monotone normalized form based on the coupling metric and the operating-point parameter. The X_opt parameter 916 may be selected according to a desired operating point, theoretical basis, calibration result, or controller policy. Multi-level phase gate 918 supports a continuous or multilevel transform implementation. Binary phase gate 920 supports a simpler two-level implementation. Continuous phase schedule 922 specifies how the applied phase varies with the control value or bucket level. These explicit structural alternatives are useful because they give later claims support for both narrow and broad embodiments. Turning now to FIG. 10, a quantum circuit architecture 1000 includes a state register 1002, an ancilla register 1004, a state preparation gate set 1006, an oracle gate block 1008, a kappa evaluation block 1010, a recognition diffusion gate block 1012, a U_phi controlled-phase gate block 1014, a measurement gate block 1016, a classical feedback line 1018, a transform-penalty control line 1020, a kappa flag output 1022, and a measurement result output 1024. FIG. 10 makes explicit that the disclosed invention is not limited to high-level algorithmic language. It also supports circuit-level realizations.

The state register 1002 stores the encoded candidate space. The ancilla register 1004 supports classification, comparison, routing, phase conditioning, or reversible helper logic. The state preparation gate set 1006 prepares the initial distribution over the candidate space. The oracle gate block 1008 marks target states. The kappa evaluation block 1010 computes or retrieves a state-dependent class signal or control value. The recognition diffusion gate block 1012 implements the weighted redistribution stage. The U_phi controlled-phase gate block 1014 implements the transform stage. The measurement gate block 1016 performs final or intermediate measurement. Classical feedback line 1018 enables hybrid control. Transform-penalty control line 1020 carries transform-penalty information. Kappa flag output 1022 carries classification output or encoded class data. Measurement result output 1024 carries the readout result.

Circuit architecture 1000 can be realized in multiple physical or logical forms. In some embodiments, ancilla register 1004 stores only binary flags. In other embodiments, it stores multibit class data. In some embodiments, kappa evaluation block 1010 is implemented as a reversible feature-extraction and thresholding routine. In some embodiments, block 1010 is instead implemented via lookup or encoded metadata, including in one embodiment a lookup table or encoded metadata structure that maps candidate-state descriptors or state-class descriptors to binary-kappa or bucketed-kappa values used by the transform stage. In some embodiments, U_phi controlled-phase gate block 1014 is decomposed into standard hardware-native controlled-phase primitives. In some embodiments, block 1014 is synthesized automatically by a compiler, including in one embodiment from a high-level phase-policy description that preserves identity treatment for marked states and preserves stronger phase treatment for the first class of non-solution candidate states than for the second class. In some embodiments, recognition diffusion gate block 1012 includes an approximate realization chosen for lower depth. These embodiments support claims to specific circuit implementations, synthesized implementations, and compiler-assisted implementations.

Turning now to FIG. 11, an adaptive control subsystem 1100 includes an iteration counter 1102, a transform-penalty updater 1104, a kappa updater 1106, an amplitude estimation block 1108, an intermediate measurement input 1110, a stroboscopic interval parameter k 1112, a transform enable gate 1114, a depth-robustness selector 1116, a convergence monitor 1118, a stop signal 1120, and an updated parameter output 1122. This figure supports adaptive embodiments, stroboscopic embodiments, and fallback embodiments.

Iteration counter 1102 tracks search progress. Transform-penalty updater 1104 may change a transform penalty parameter with time, with phase of search, with noise conditions, or with confidence conditions. Kappa updater 1106 may revise the classification or scoring policy as execution proceeds. Amplitude estimation block 1108 may estimate whether the process is converging as intended. Intermediate measurement input 1110 can be used in embodiments where partial observations are allowed or helpful. Stroboscopic interval parameter k 1112 governs embodiments in which the transform is not applied every iteration. Transform enable gate 1114 determines whether the transform is active for the present cycle. Depth-robustness selector 1116 trades off suppression aggressiveness against hardware budget or error tolerance. Convergence monitor 1118 evaluates whether a stopping or mode-transition criterion has been met. Stop signal 1120 triggers termination or readout. Updated parameter output 1122 communicates updated control values.

FIG. 11 supports many useful controller policies. In a fixed-parameter embodiment, blocks 1104 and 1106 simply pass through initial values. In an adaptive embodiment, block 1104 decreases a transform penalty parameter when instability rises or when classification confidence falls, including in one embodiment decreasing the transform penalty parameter when estimated noise exceeds a threshold or when classification confidence falls below a threshold. In another adaptive embodiment, block 1104 increases a transform penalty parameter after an initial gentle phase when classification confidence remains above a threshold and an effective-domain estimate continues to indicate a practical reduction in search burden relative to a nominal-domain baseline. In a stroboscopic embodiment, parameter k 1112 may be larger than one so that the transform is inserted only periodically. In a fallback embodiment, transform enable gate 1114 may disable the transform entirely when the search is effectively unstructured or when kappa is uninformative. In a hardware-aware embodiment, depth-robustness selector 1116 chooses between a richer continuous transform and a simpler binary transform. These policy alternatives are expressly supported so that later claims may recite not only the transform itself but also how and when it is governed.

Turning now to FIG. 12, an application embodiment matrix 1200 includes a database-search embodiment 1202, a SAT-solving embodiment 1204, a graph-optimization embodiment 1206, a cryptanalysis embodiment 1208, a machine-learning embodiment 1210, a corruption-pattern kappa source 1212, a clause-violation kappa source 1214, a graph-property kappa source 1216, a leakage-pattern kappa source 1218, a generalization-gap kappa source 1220, a solution readout adapter 1222, and an application-specific post-processor 1224. FIG. 12 is significant because it shows that the disclosed architecture is general across multiple technical domains rather than being tied to one narrow use case.

In database-search embodiment 1202, corruption-pattern kappa source 1212 may identify entries, regions, or sectors likely to be undesirable, unstable, or otherwise less promising. In SAT-solving embodiment 1204, clause-violation kappa source 1214 may identify assignments with high violation burden. In graph-optimization embodiment 1206, graph-property kappa source 1216 may identify candidates with unfavorable graph signatures. In cryptanalysis embodiment 1208, leakage-pattern kappa source 1218 may identify states associated with hardware leakage or side-channel sensitivity. In machine-learning embodiment 1210, generalization-gap kappa source 1220 may identify hyperparameter regions expected to generalize poorly. Solution readout adapter 1222 converts the measured candidate into a domain-appropriate result, and application-specific post-processor 1224 can validate, refine, rank, or otherwise process the output.

FIG. 12 also supports a consistent architectural distinction between core search logic and domain-specific adapters. The core search logic includes oracle marking, recognition diffusion, and category-dependent transform behavior. The domain-specific portions supply the source of kappa and the meaning of the readout. All illustrated application embodiments share the same inventive core of state categorization via a vantage metric, recognition-weighted diffusion, and category-dependent transform control, and the application-specific differences change the source of kappa or the output interpretation without changing that core control loop. This distinction is useful for claim breadth because it permits independent claims directed to the core architecture and dependent claims directed to particular application classes or kappa sources. Accordingly, the common inventive concept across method, system, and computer-readable-medium embodiments is the same three-stage, repeatable search-control cycle comprising oracle marking, recognition diffusion defined relative to a recognition-weighted state representation derived from kappa, and a state-dependent transform that applies different phase treatments to different state classes, optionally under enable-versus-bypass control responsive to objective confidence and objective noise estimates. The domain-specific embodiments differ in how kappa is generated and how an output is interpreted, but they share the same core unitary control loop and the same architecture-level components and interfaces, thereby maintaining unity of invention around the disclosed recognition-enhanced amplitude-control mechanism.

Returning now to the disclosed process more generally, the architecture can be described in a representative mathematical form. A conventional Grover step may be represented as G=D*O_hat. A representative recognition-enhanced step may be represented as G_phi =U_phi * D_rec*O_hat. A recognition diffusion operator may be represented as a reflection about a recognition-weighted state representation, where the recognition-weighted state representation is normalized using a normalization factor and weighted according to the weighting function. In representative embodiments, w(x) is monotone in kappa(x). In representative transform embodiments, the state-dependent transform applies a phase determined from kappa(x) and a normalization factor for non-solution states, and applies an identity treatment for solution states. In representative binary embodiments, marked states receive identity treatment, vantage-likely states receive a stronger phase treatment, and other non-solution states receive a weaker phase treatment. These expressions are illustrative and support implementation; they do not limit the invention to only one mathematically phrased embodiment.

In phi-based embodiments, phi may be taken as the golden ratio, and reciprocal relationships associated with phi may be used to define relative phase treatments. In some embodiments, a transform penalty parameter is selected according to a ratio based on phi. In some embodiments, a secondary phase ratio is selected according to phi and a selected penalty parameter. In some embodiments, an alternative phi-based phase schedule is used. In broader embodiments, the use of phi is replaced by another schedule while preserving the essential architectural principle of different transform treatment for different state categories. This is important because some later claims may specifically recite phi-governed embodiments while others may recite a broader class of state-dependent transform architectures.

Effective-domain behavior may also be expressed mathematically in representative embodiments. In one example, N_eff=N*(1−f_vantage). In another, a weighted or confidence-adjusted analogue may be used. In one representative analysis regime, iteration behavior is evaluated with respect to the effective domain and a phi-based schedule. In another, the controller need not use a literal asymptotic expression at all and may instead rely on empirical iteration planning or a learned schedule, including a schedule selected according to estimated noise, classification confidence, and whether transform-enabled operation outperforms bypassed operation in prior benchmarking. These alternatives are all supported so that the invention is not limited to one analytical framework.

The disclosed architecture also supports many operational alternatives beyond those expressly shown in the figures. In one class of embodiments, kappa is computed entirely before execution and never changed. In another class, kappa is refined during execution. In one class, the transform penalty parameter is fixed. In another, the transform penalty parameter is adaptive. In one class, the transform is always enabled. In another, it is enabled only when a controller determines that the current regime justifies it, including in one embodiment when classification confidence satisfies a threshold and an effective-domain estimate indicates a practical reduction in search burden relative to a nominal-domain baseline. In one class, the transform is binary. In another, it is continuous. In one class, the oracle is exact. In another, it is staged or approximate. In one class, the system is local. In another, it is distributed across a client device, a remote classical controller, and a remote quantum backend. These classes of embodiments are expressly included to support robust claim drafting and to reduce the need for later supplementation.

Failure handling is also expressly supported. If kappa is unavailable, unreliable, too costly to compute, too noisy, or otherwise unsuitable, the controller may widen the weaker-suppression class, reduce a transform penalty parameter, increase the stroboscopic interval, fall back to binary mode, bypass the transform, or reduce to standard Grover-like operation. If hardware limits are too severe for a selected continuous transform, the controller may choose a simpler binary transform or a weaker approximation. If convergence is not occurring as expected, the controller may alter a transform penalty parameter, alter kappa thresholds, or stop early. These fallback and mitigation pathways are part of the disclosed invention and are not merely optional engineering afterthoughts.

Validation, audit, and reproducibility support are likewise included. In some embodiments, the controller stores a selected transform penalty parameter value, the classification policy, the chosen branch between binary and continuous modes, the effective-domain estimate, the transform schedule, and the measurement result. In some embodiments, this information is used for benchmarking, including benchmarking transform-enabled runs against bypassed runs with common problem instances, common oracle settings, and common measurement budgets. In some embodiments, it is used for regulatory or audit records. In some embodiments, it is used only for engineering verification. The invention therefore supports embodiments in which operation and recordkeeping are distinguished rather than conflated.

The disclosed architecture further supports classical-quantum hybrid operation. A classical preprocessing stage may generate kappa or related structural information before quantum execution. A quantum stage may then perform the search loop. A classical post-processing stage may validate or refine the result. Such preprocessing may use one or more of the inputs and analyzers already described. Such post-processing may use solution readout adapter 1222 and application-specific post-processor 1224. The hybrid nature of these embodiments is explicitly disclosed so that later claims may address local, remote, hybrid, or distributed implementations without overreaching the written description.

The disclosed architecture further supports simulator, compiler, and cloud-service embodiments. In some compiler-mediated embodiments, compiled instructions cause a quantum computing system to implement the state-dependent transform using an ancilla register and one or more controlled-phase gates that apply an identity treatment to marked states, a stronger phase treatment to a stronger-suppression class, and a weaker phase treatment to a weaker-suppression class. A simulator embodiment can emulate the disclosed search and compare transform-enabled versus bypassed modes. A compiler embodiment can lower a high-level search description into gate blocks corresponding to 1006, 1008, 1010, 1012, 1014, and 1016. A cloud-service embodiment can receive a job through input 102, route execution through a remote controller corresponding to 114, use remote or local models corresponding to 122 and 124, and return results through interface 128. These embodiments help ensure that the invention is not construed as limited to a single deployment environment.

A database-search example further illustrates the architecture. A set of candidate records is encoded into a search domain. Corruption-pattern kappa source 1212 identifies a subset of non-solution states associated with unstable or corrupted regions. Oracle subsystem 106 marks candidate records satisfying a query or verification rule. Recognition diffusion subsystem 108 redistributes amplitude using weights influenced by the corruption-related classification. Minimal-overhead transform subsystem 110 applies stronger penalty to the corruption-associated class and weaker penalty to other non-solution records. Measurement subsystem 112 reads out a candidate record, result decoder 126 maps that candidate to the corresponding database output, and output interface 128 provides the result. In this example, the benefit is not merely that a result is found, but that the search process is controlled to avoid wasting search dynamics on states judged especially undesirable.

A satisfiability example further illustrates the architecture. Candidate assignments are encoded as states. Clause-violation kappa source 1214 identifies assignments with high violation burden. Oracle subsystem 106 marks satisfying assignments or sufficiently promising assignments depending on the embodiment. Recognition diffusion subsystem 108 uses weights influenced by that violation information. Minimal-overhead transform subsystem 110 more strongly suppresses the conflict-heavy class. The process then iterates until a stop criterion is met. This example illustrates that the invention is not confined to a search problem with external corruption or hardware noise; it also applies where the search structure itself supplies the distinction among non-solution states.

A graph-optimization example further illustrates the architecture. Candidate graph structures, cuts, or paths are encoded. Graph-property kappa source 1216 scores candidates based on degree, centrality, subgraph participation, or another graph-derived property. Oracle subsystem 106 marks candidates satisfying a target rule or objective threshold. Recognition diffusion subsystem 108 biases redistribution using the graph-informed classification. Minimal-overhead transform subsystem 110 applies stronger transform treatment to graph candidates that are less desirable. Measurement and decoding then produce a graph-domain answer. This example supports graph-search and graph-optimization claim positions.

A cryptanalysis example further illustrates the architecture. Candidate keys or key fragments are encoded. Leakage-pattern kappa source 1218 identifies states aligned with unfavorable or side-channel-sensitive behavior. Oracle subsystem 106 marks candidates passing a verification or consistency check. Recognition diffusion subsystem 108 and minimal-overhead transform subsystem 110 then act on the leakage-informed classification. This example supports claims in which the transform is used not merely for abstract structure exploitation but for noise-robust or leakage-aware control.

A machine-learning example further illustrates the architecture. Candidate hyperparameter settings or model configurations are encoded. Generalization-gap kappa source 1220 identifies settings predicted to generalize poorly. Oracle subsystem 106 marks acceptable candidates according to a validation or surrogate criterion. Recognition diffusion subsystem 108 and minimal-overhead transform subsystem 110 then steer the search away from the less desirable region. Measurement and decoding output a candidate model setting. This example supports claims to machine-learning search without requiring that the invention be limited to that field.

The disclosure also expressly supports a fully unstructured fallback regime. If no useful kappa signal exists, the controller can set a transform penalty parameter to zero, omit the transform, or otherwise reduce the process to standard Grover-like behavior. This disclosure is important because it makes clear that the invention includes not only the stronger-suppression regime but also the logic for determining when that regime should not be used. This helps distinguish the invention from a rigid algorithm that is always applied regardless of context.

The foregoing detailed description is intended to be substantially more than a summary of the invention. It provides architecture-level, process-level, transform-level, controller-level, circuit-level, deployment-level, fallback-level, and application-level disclosure tied to FIGS. 1-12 and their reference numerals. It also provides multiple alternative embodiments, operational distinctions, and examples designed to support claims of varying scope. The drawings stop at FIG. 12, and no additional figures are required or introduced.

The invention is not limited to the exact values, equations, schedules, controller rules, hardware partitions, data structures, or deployment models expressly described. Binary and continuous kappa embodiments, fixed and adaptive transform-penalty embodiments, transform-every-iteration and stroboscopic embodiments, local and remote embodiments, simulator and hardware embodiments, compiler and non-compiler embodiments, and standalone and combined embodiments may be used singly or in combination. Unless a later claim expressly states otherwise, the described values, examples, and implementation choices are illustrative rather than limiting. Equivalent structures, equivalent transform schedules, equivalent weighting rules, equivalent circuit decompositions, equivalent deployment models, and equivalent controller policies may be used without departing from the scope of the invention as defined by the claims.

1. A computer-implemented quantum search method comprising: preparing, by a quantum computing system, a quantum state representing a plurality of candidate states in a search domain; applying, by the quantum computing system, an oracle operation configured to mark one or more candidate states that satisfy a target criterion; determining, by the quantum computing system, a state-dependent vantage metric for at least a subset of non-solution candidate states, the vantage metric distinguishing a first class of non-solution candidate states from a second class of non-solution candidate states based on machine-determined data selected from problem-structure data, environment-coupling data, prior-distribution data, or classifier output, wherein determining comprises executing a classifier or evaluator circuit on an ancilla register to output a kappa flag used to control a multiplexed phase gate that implements a state-dependent transform; applying, by the quantum computing system, a recognition diffusion operation comprising a unitary reflection about a recognition-weighted state representation derived from the vantage metric; applying, by the quantum computing system, the state-dependent transform that (i) applies a first phase treatment to the one or more marked candidate states, (ii) applies a second phase treatment to the first class of non-solution candidate states, and (iii) applies a third phase treatment to the second class of non-solution candidate states, the second phase treatment differing from the third phase treatment; repeating application of the oracle operation, the recognition diffusion operation, and the state-dependent transform for a selected number of iterations; and measuring the quantum state after the selected number of iterations to obtain an output identifying a candidate solution, wherein repeating comprises enabling the state-dependent transform when (a) a classification-confidence value associated with the vantage metric is at least a confidence threshold C_min and (b) a basis-dependent noise metric is at least a noise threshold N_min, and otherwise bypassing the state-dependent transform by setting a transform penalty parameter to zero or omitting the state-dependent transform prior to measurement, wherein the classification-confidence value is a machine-computed scalar in a closed interval from 0 to 1 computed using at least one objective basis selected from a normalized classifier margin, an agreement rate among two or more analyzers producing the vantage metric, a held-out validation accuracy associated with a kappa classifier, or a posterior probability produced by a Bayesian model, and wherein the basis-dependent noise metric is a machine-computed scalar computed using at least one objective basis selected from a decoherence-rate estimate derived from a measured T1 or T2 value, a gate-error estimate for gate families used by the oracle operation or the state-dependent transform, a leakage probability estimate or readout bias estimate, or an environment-coupling score associated with basis-state susceptibility.

2. The method of claim 1, wherein the first phase treatment comprises an identity treatment applied to the one or more marked candidate states.

3. The method of claim 1, wherein the second phase treatment comprises a stronger phase treatment for the first class of non-solution candidate states, the third phase treatment comprises a weaker phase treatment for the second class of non-solution candidate states, and the second phase treatment is a stronger penalty phase than the third phase treatment.

4. The method of claim 1, wherein the vantage metric is a binary metric that assigns the first class of non-solution candidate states a first value and the second class of non-solution candidate states a second value, and wherein the first value is assigned when a computed score S(x) satisfies S(x) greater than or equal to tau and the second value is assigned otherwise.

5. The method of claim 1, wherein the vantage metric is a continuous or multi-level metric and the state-dependent transform applies a phase schedule as a function of the vantage metric using an ancilla register and one or more controlled-phase gates according to a classification value associated with the vantage metric, including in one embodiment a continuous score derived from a coverage function that increases with a coupling metric and is normalized by an operating-point parameter.

6. The method of claim 1, wherein determining the state-dependent vantage metric comprises deriving the vantage metric from at least one of problem structure, an environment-coupling model, a Bayesian prior, a rule-based analyzer, a learned model, a graph-property metric, a clause-violation metric, a leakage-pattern metric, a corruption-pattern metric, or a machine-learning generalization metric, including in one embodiment a computed undesirability score S(x) derived from one or more of clause-violation count, graph-degree or centrality score, leakage-pattern match score, or corruption-pattern match score.

7. The method of claim 1, wherein the recognition-weighted state representation is based on a weighting function that is monotone in the vantage metric, and wherein the recognition diffusion operation is implemented by preparing the recognition-weighted state representation, applying a phase flip, and unpreparing the recognition-weighted state representation to realize a Householder reflection.

8. The method of claim 1, further comprising determining an effective domain value associated with a portion of the search domain remaining materially relevant after stronger suppression of the first class of non-solution candidate states, and selecting the selected number of iterations based at least in part on the effective domain value and on a comparison between an iteration budget computed from the effective domain value and a baseline iteration budget computed from a nominal domain size.

9. The method of claim 1, further comprising, in response to a determination that the vantage metric is unavailable or insufficiently informative, attenuating the state-dependent transform, bypassing the state-dependent transform, or setting a transform penalty parameter to zero, wherein the determination that the vantage metric is insufficiently informative comprises determining that classification-confidence is below the confidence threshold C_min, that an effective-domain estimate fails to indicate a practical reduction in search burden relative to a nominal-domain baseline, or that the basis-dependent noise metric exceeds a threshold associated with an error budget or hardware-depth constraint, and otherwise causing application of the state-dependent transform every iteration or every kth iteration according to a stroboscopic schedule.

10. A quantum search system comprising: a quantum processor configured to store a quantum state representing a plurality of candidate states; a state preparation subsystem configured to prepare the quantum state; an oracle subsystem configured to mark one or more candidate states that satisfy a target criterion; a kappa generator configured to determine a vantage metric for at least a subset of non-solution candidate states, the vantage metric distinguishing a first class of non-solution candidate states from a second class of non-solution candidate states based on machine-determined data selected from problem-structure data, environment-coupling data, prior-distribution data, or classifier output; a recognition diffusion subsystem configured to apply a recognition diffusion operation comprising a unitary reflection about a recognition-weighted state representation derived from the vantage metric; a transform subsystem configured to apply a first phase treatment to the one or more marked candidate states, a second phase treatment to the first class of non-solution candidate states, and a third phase treatment to the second class of non-solution candidate states, the second phase treatment differing from the third phase treatment; a controller configured to cause repeated application of the oracle subsystem, the recognition diffusion subsystem, and the transform subsystem for a selected number of iterations; and a measurement subsystem configured to measure the quantum state after the selected number of iterations to produce an output identifying a candidate solution, wherein the controller is configured to enable the transform subsystem when a classification-confidence value associated with the vantage metric exceeds a confidence threshold and an estimated basis-dependent noise metric exceeds a noise threshold, and otherwise to bypass the transform subsystem by setting a transform penalty parameter to zero or omitting transform application prior to measurement.

11. The system of claim 10, wherein the kappa generator is configured to determine the vantage metric from at least one of problem-structure data, environment-coupling data, Bayesian-prior data, graph-property data, clause-violation data, leakage-pattern data, corruption-pattern data, or machine-learning model-selection data, including by computing an undesirability score from one or more of clause-violation count, graph-degree or centrality score, leakage-pattern match score, or corruption-pattern match score.

12. The system of claim 10, wherein the transform subsystem is configured such that the first phase treatment comprises an identity treatment, the second phase treatment comprises a stronger phase treatment for the first class of non-solution candidate states, the third phase treatment comprises a weaker phase treatment for the second class of non-solution candidate states, and a penalty ratio between the second phase treatment and the third phase treatment is governed by phi.

13. The system of claim 10, wherein the recognition diffusion subsystem is configured to implement a weighted reflection about a state representation derived from a weighting function that is monotone in the vantage metric, including by preparing a recognition-weighted state, applying a phase flip, and unpreparing the recognition-weighted state to realize a Householder reflection about the recognition-weighted state.

14. The system of claim 10, further comprising an effective-domain estimator configured to determine an effective domain value representing a practical search burden after stronger suppression of the first class of non-solution candidate states, wherein in one embodiment the effective-domain estimator computes the effective domain value from a nominal domain size and from a measured or estimated fraction of candidate states assigned to a stronger-suppression class, and wherein in another embodiment the effective-domain estimator computes a confidence-adjusted effective-domain analogue based on classification confidence associated with the vantage metric and compares the confidence-adjusted effective-domain analogue to a nominal-domain baseline for transform-enable control.

15. The system of claim 10, wherein the controller is configured to modify a transform penalty parameter, modify the vantage metric, or selectively bypass the transform subsystem based on at least one of an iteration count, a convergence estimate, a classification-confidence value associated with the vantage metric, or a hardware-depth constraint, and wherein the controller enables the transform subsystem when the classification-confidence value is at least a confidence threshold C_min and an effective-domain estimate indicates a practical reduction in search burden relative to a nominal-domain baseline, and otherwise bypasses or attenuates the transform subsystem, including by decreasing the transform penalty parameter when the basis-dependent noise metric exceeds a noise threshold N_min or when the classification-confidence value falls below the confidence threshold C_min.

16. The system of claim 10, wherein the transform subsystem is configured to implement the state-dependent transform using an ancilla register and one or more controlled-phase gates that apply different phase treatments according to a classification value associated with the vantage metric, and wherein the controller is configured to cause application of the state-dependent transform every iteration or every kth iteration according to a stroboscopic schedule.

17. A non-transitory computer-readable medium storing instructions that, when executed by at least one processor associated with a quantum computing system, cause the quantum computing system to: prepare a quantum state representing a plurality of candidate states in a search domain; apply an oracle operation configured to mark one or more candidate states that satisfy a target criterion; determine a vantage metric for at least a subset of non-solution candidate states, the vantage metric distinguishing a first class of non-solution candidate states from a second class of non-solution candidate states based on machine-determined data selected from problem-structure data, environment-coupling data, prior-distribution data, or classifier output, wherein determining the vantage metric comprises executing a classifier or evaluator circuit on an ancilla register to output a kappa flag used to control a multiplexed phase gate that implements the state-dependent transform; apply a recognition diffusion operation comprising a unitary reflection about a recognition-weighted state representation derived from the vantage metric; apply a state-dependent transform that applies an identity treatment to the one or more marked candidate states, applies a stronger phase treatment to the first class of non-solution candidate states, and applies a weaker phase treatment to the second class of non-solution candidate states; repeat application of the oracle operation, the recognition diffusion operation, and the state-dependent transform for a selected number of iterations; and measure the quantum state to obtain an output identifying a candidate solution, wherein the instructions cause the quantum computing system to enable the state-dependent transform when a classification-confidence value associated with the vantage metric exceeds a confidence threshold and an estimated basis-dependent noise metric exceeds a noise threshold, and otherwise to bypass the state-dependent transform by setting a transform penalty parameter to zero or omitting the state-dependent transform prior to measurement.

18. The non-transitory computer-readable medium of claim 17, wherein the instructions further cause the quantum computing system to implement the state-dependent transform using an ancilla register and one or more controlled-phase gates that apply different phase treatments according to a classification value associated with the vantage metric, to determine an effective domain value from a nominal domain size and from a measured or estimated fraction of candidate states assigned to the first class of non-solution candidate states and to select the selected number of iterations based at least in part on the effective domain value, and, in response to a determination that the vantage metric is unavailable or insufficiently informative, to attenuate the state-dependent transform, bypass the state-dependent transform, or set a transform penalty parameter to zero, and otherwise, when a classification-confidence value is at least a confidence threshold C_min and a basis-dependent noise metric is at least a noise threshold N_min, to cause application of the state-dependent transform every iteration or every kth iteration according to a stroboscopic schedule, including decreasing the transform penalty parameter when the basis-dependent noise metric exceeds the noise threshold N_min or when the classification-confidence value falls below the confidence threshold C_min.

19. The method of claim 1, wherein the state-dependent transform comprises a diagonal unitary in a computational basis and applies (i) an identity phase treatment to the one or more marked candidate states, (ii) a phase rotation of angle beta to the first class of non-solution candidate states, and (iii) a phase rotation of angle beta divided by phi to the second class of non-solution candidate states, where beta is a transform penalty parameter and phi is the golden ratio.

20. The method of claim 1, further comprising generating an execution log that stores at least one of: a current value of the transform penalty parameter beta, a current kappa policy or threshold, a current classification-confidence value, a current basis-dependent noise metric value, an enable-versus-bypass decision for the state-dependent transform, a selected stroboscopic interval k when used, and a measurement result, thereby providing reproducible audit data for the repeated application of the oracle operation, the recognition diffusion operation, and the state-dependent transform.
